(19) United States
(12) Patent Application Publication
(10) Pub. No.: US 2009/0091728 A1
(43) Pub. Date: Apr. 9, 2009

(54) Compact High Aperture Folded Catadioptric Projection Objective

(75) Inventor: Alexander EPPLE, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG, Oberkochen (DE)

(21) Appl. No.: 11/864,423

(22) Filed: Sep. 28, 2007

(51) Int. Cl. G03B 27/54; G02B 17/08

(52) U.S. Cl. 355/67; 359/730

(57) ABSTRACT

A catadioptric projection objective has a plurality of optical elements arranged along an optical axis to image a pattern from an object field in an object surface of the objective to an image field in an image surface region of the objective at an image-side numerical aperture NA≧1.35 with electromagnetic radiation defining an operating wavelength λ. The optical elements form a first objective part configured to image the pattern from the object surface into a first intermediate image, a second objective part configured to image the first intermediate image into a second intermediate image, the second objective part including a concave mirror having a reflective mirror surface positioned at or close to a pupil surface; and a third objective part configured to image the second intermediate image into the image surface. A first deflecting mirror is arranged to deflect radiation from the object surface towards the concave mirror, and a second deflecting mirror is arranged to deflect radiation from the concave mirror towards the image surface such that the image surface is parallel to the object surface. A geometrical distance L between the object surface and the image surface is smaller than or equal to 1950 mm.

### BACKGROUND OF THE INVENTION

1. Field of the Invention

The invention relates to a catadioptric projection objective which may be used in a microlithographic projection exposure apparatus to expose a radiation-sensitive substrate arranged in the region of an image surface of the projection objective with at least one image of pattern of a mask that is arranged in the region of an object surface of the projection objective. The invention also relates to a projection exposure apparatus which includes such catadioptric projection objective.

2. Description of the Related Art

Microlithographic projection exposure methods and apparatus are used to fabricate semiconductor components and other finely patterned components. A microlithographic exposure process involves using a mask (reticle) that carries or forms a pattern of a structure to be imaged, for example a line pattern of a layer of a semiconductor component. The pattern is positioned in a projection exposure apparatus between an illumination system and a projection objective in a region of the object surface of the projection objective. Primary radiation from the ultraviolet electromagnetic spectrum (UV radiation) is provided by a primary radiation source and transformed by optical components of the illumination system to produce illumination radiation directed at the pattern of the mask. The radiation modified by the mask and the pattern passes through the projection objective, which forms an image of the pattern in the image surface of the projection objective, where a substrate to be exposed is arranged. The substrate, e.g. a semiconductor wafer, normally carries a radiation-sensitive layer (photoresist).

In order to create even finer structures, it is sought to both increase the image-side numerical aperture (NA) of the projection objective and employ shorter wavelengths, preferably ultraviolet radiation with wavelengths less than about 260 nm, for example 248 nm, 193 nm or 157 nm.

Purely refractive projection objectives have been predominantly used for optical lithography in the past. However, correction of elementary imaging errors, such as correction of chromatic aberrations and correction for the Petzval sum (image field curvature) become more difficult as NA is increased and shorter wavelengths are used.

One approach for obtaining a flat image surface and good correction of chromatic aberrations is the use of catadioptric optical systems, which combine both refracting elements, such as lenses, and reflecting elements with optical power, such as at least one concave mirror. While the contributions of positive-powered and negative-powered lenses in an optical system to overall power, image field curvature and chromatic aberrations are opposite to each other, a concave mirror has positive power like a positive-powered lens, but the opposite effect on image field curvature without contributing to chromatic aberrations.

A concave mirror is difficult to integrate into an optical system, since it sends the radiation right back in the direction it came from. Configurations integrating a concave mirror without causing problems due to beam vignetting and pupil obscuration are desirable.

A variety of concepts with specific advantages and drawbacks have been used in the past. Catadioptric projection objectives without intermediate image or with one or more real intermediate images have been designed. Separation of a projection beam section directed at a concave mirror and a projection beam section reflected by a concave mirror may be accomplished in a variety of ways. Polarization selective physical beam splitting may be employed. Alternatively, geometrical beam separation may be employed, for example by using one or more planar deflecting mirrors to fold the optical axis of the projection objective. Catadioptric projection objectives with one straight, unfolded optical axis have also been designed.

Further, the overall size of the optical systems both with regard to diameter of the optical components and with regard to system length tends to increase as the image-side NA is increased. In this regard, high prices of transparent materials with sufficient optical quality and sizes large enough for fabricating large lenses represent problems. Additionally, installation space for incorporating a projection objective into a microlithographic projection exposure apparatus may be limited. Therefore, measures that allow reducing the number and sizes of lenses and simultaneously contribute to maintaining, or even improving, imaging fidelity are desired.

### SUMMARY OF THE INVENTION

It is one object of the invention to provide a catadioptric projection objective which allows very high resolution to be achieved, with a compact design with optimized dimensions.

It is another object of the invention to provide catadioptric projection objectives suitable for immersion lithography at image side numerical apertures of at least NA=1.35 having moderate size and material consumption.

To address these and other objects the invention, according to one formulation of the invention, provides a catadioptric projection objective comprising:

a plurality of optical elements arranged along an optical axis to image a pattern from an object field in an object surface of the objective to an image field in an image surface region of the objective at an image-side numerical aperture NA with electromagnetic radiation defining an operating wavelength λ, including:

a first objective part configured to image the pattern from the object surface into a first intermediate image, and having a first pupil surface;

a second objective part configured to image the first intermediate image into a second intermediate image, and having a second pupil surface optically conjugate to the first pupil surface, the second objective part including a concave mirror having a reflective mirror surface positioned at or close to the second pupil surface;

a third objective part configured to image the second intermediate image into the image surface, and having a third pupil surface optically conjugate to the first and second pupil surface;

a first deflecting mirror arranged to deflect radiation from the object surface towards the concave mirror;

a second deflecting mirror arranged to deflect radiation from the concave mirror towards the image surface such that the image surface is parallel to the object surface;

wherein NA≧1.35 and a geometrical distance L between the object surface and the image surface is smaller than or equal to 1950 mm.

It has been found that a catadioptric projection objective having two real intermediate images may be designed to obtain very high image-side numerical aperture in an image field large enough to allow microlithographic applications while avoiding problems such as vignetting. Further, where an off-axis object field and an image field are used, pupil obscuration can also be avoided in systems having high image-side NA. The projection objective may have exactly three consecutive objective parts and exactly two real intermediate images. Each of the first to third objective part may be an imaging subsystem performing two consecutive Fourier-transformations (2f-system), and there may be no additional objective part in addition to the first to third objective parts. Where exactly two real intermediate images are provided, a large number of degrees of freedom for the optical designer is provided in optical systems which may be manufactured with reasonable size and complexity. Large image side numerical apertures in image fields suitable for lithographic purpose are made possible.

The second objective part includes a concave mirror having a reflective mirror surface positioned at or close to the second pupil surface. The first and the third objective part may be purely dioptric (lenses only), whereas the second objective part may include one or more lenses in addition to the concave mirror, thereby forming a catadioptric second objective part.

A first deflecting mirror is arranged to deflect radiation coming from the object surface in the direction of the concave mirror and the second folding mirror is arranged to deflect radiation coming from the concave mirror in the direction of the image plane. This folding geometry allows to arrange the segments of the optical axis defined by the optical elements of the first objective part and the third objective part essentially coaxial, i.e. exactly coaxial or with only a slight lateral offset, the offset being small in relation to the typical lens diameter.

A negative group comprising at least one negative lens may be arranged in front of the concave mirror on a reflecting side thereof in a double pass region such that radiation passes at least twice in opposite directions through the negative group. The negative group may be positioned in direct proximity to the concave pupil mirror in a region near the second pupil surface, where this region may be characterized by the fact that the marginal ray height (MRH) of the imaging is greater than the chief ray height (CRH). Preferably, the marginal ray height is at least twice as large, in particular at least 5 to 10 times as large, as the chief ray height in the region of the negative group. A negative group in the region of large marginal ray heights can contribute effectively to the chromatic correction, in particular to the correction of the axial chromatic aberration, since the axial chromatic aberration of a thin lens is proportional to the square of the marginal ray height at the location of the lens (and proportional to the refractive power and to the dispersion of the lens). Added to this is the fact that the projection radiation passes twice, in opposite through-radiating directions, through a negative group arranged in direct proximity to a concave mirror, with the result that the chromatically overcorrecting effect of the negative group is utilized twice. The negative group may e.g. consist of a single negative lens or contain at least two negative lenses.

In some embodiments the image-side NA is equal to or greater than 1.40, or equal to or greater than 1.45, or equal to or greater than 1.50. The image-side NA may be 1.55 or higher, which provides potential for highest resolutions in the order of R=35 nm or below at a nominal operating wavelengths λ=193 nm. At the same time the overall track length L (geometrical distance between object surface and image surface) may be kept at moderate values, such as 1900 mm or less, or 1800 mm or less, or 1700 mm or less or 1600 mm or less, or 1500 mm or less. For example, the conditions NA≧1.45 and L≧1700 mm may hold simultaneously.

A projection objective may be characterized by the size and shape of the object field which can be effectively imaged by the projection objective without vignetting at a given numerical aperture. The corresponding object field will be denoted in “effective object field” in the following. The size of the effective object field and the size of the corresponding effective image field are related through the magnification factor of the projection objective. Often it is desired to maximize the size of the effective fields in order to improve productivity of manufacturing processes involving the projection objective.

A further characterizing feature is the size of the object field for which the projection objective must be sufficiently corrected with respect to image aberrations to obtain the desired performance. The aberrations include chromatic aberrations, image curvature, distortion, spherical aberrations, astigmatism etc. The field, for which the projection objective must be sufficiently corrected, will be denoted “design object field” in the following. The design object field is a field centred about the optical axis on the object side. The projection objective may be characterized by the outer radius R_{DOF} of the design object field, i.e. the design object field radius (also denoted as “object height” OBH). A projection objective is essentially corrected with respect to image aberrations in zones having radial coordinates smaller than R_{DOF} and the projection objective need not be fully corrected in zones having radial coordinates larger than R_{DOF}. As the number and sizes of optical elements typically increase drastically if the size of the design object field is to be increased, it is generally desired to minimize the size of the design object field.

Some embodiments exhibit relatively small ratios between the track length L and the size (radius) of the design object field indicating that relatively large sized effective fields may be used for exposure while at the same time the overall axial dimension of the projection objective may be kept moderate. In some embodiments with magnification ratio β of the projection objective the condition 120>B=|L/(R_{DOF}*β)| holds. Sometimes the condition B<110 and/or B<100 and/or B<95 holds.

In some embodiments a field lens with a positive refractive power is arranged geometrically between the first folding mirror and the concave mirror. The field lens may be positioned in a region close to the first intermediate image. This position is optically between the first intermediate image and the concave mirror if the first intermediate image is created optically upstream, i.e. before the field lens in light propagation direction. The first intermediate image may also be positioned optically down-stream, i.e. behind the field lens, or may partly extend into the field lens.

In some embodiments the field lens is arranged geometrically between the concave mirror and the deflecting mirrors in a region through which the beam passes twice in such a manner that a first lens area of the field lens is arranged in the beam path between the object plane and the concave mirror, and a second lens area of the field lens is arranged in the beam path between the concave mirror and the image plane. Typically the first and second lens areas overlap substantially. A double pass field lens may act very effectively as it is used twice in opposite directions by the radiation passing from the object surface to the image surface.

The enlargement of numerical aperture which is desired in order to achieve very high resolutions frequently leads in conventional systems to an increase in size of the intermediate images, which may lead to a significant increase in the diameter of the optical components which are located near the intermediate images. Providing a field lens counteracts this effect. Providing a double pass positive field lens essentially allows shifting optical power from field lens groups in the first and third objective parts into the second objective part, thereby allowing to reduce size and optical power of the field lens groups of the first and third objective part. As a result, a more compact design with reduced system length may be obtained.

The expression “field lens” is used synonymously with the term “field lens group” and encompasses an individual lens or a lens group with at least two individual lenses. The expression takes account of the fact that the function of a lens can also be carried out by two or more lenses (splitting of lenses). In some embodiments the field lens is a single lens. The refractive power of the field lens may be arranged close to the nearest field surface, that is to say in the optical vicinity of a field surface. This region close to a field surface may be distinguished in particular by the chief ray height CRH of the imaging being large in comparison to the marginal ray height MRH.

The expression “intermediate image” describes the area where adjacent aperture rays (rays running from one object field point to different locations in the entrance pupil) cross each other. In general this is an axial region which extends at least between a paraxial intermediate image and a marginal ray intermediate image. Depending on the correction state of the intermediate image, this area may extend over a certain axial range in which case, by way of example, the paraxial intermediate image may be located in the light path upstream or downstream of the marginal ray intermediate image, depending on the spherical aberration (overcorrection or undercorrection). For off-axis field points field aberrations, such as coma and astigmatism, may also influence the axial extension of an intermediate image. The paraxial intermediate image and the marginal ray intermediate image may also essentially coincide. The intersection of rays originating from a common field point at different apertures indicates the existence of a “caustic condition”. Caustic conditions may occur in the region of an intermediate image having aberrations such as coma.

For the purposes of this application, an optical element A, for example a field lens, is located “between” an intermediate image and another optical element B when at least a portion of the optical element A is located between the (generally axially extended) intermediate image and the optical element B. The intermediate image may thus also partially extend beyond an optical surface which, for example, may be advantageous for correction purposes.

The intermediate image may be located completely outside optical elements. Where parts of an intermediate image are located on optical surfaces or inside optical elements, imperfections such as dust particles or scratches or bubbles may stop out a relatively large pupil area of some field points due to the fact that some of the rays of a field point cross each other, i.e. hit the same point on the optical element. Thus, having caustics on optical surfaces or in optical elements requires high quality surfaces with respect to dust particles, scratches, bubbles and comparable imperfections. These requirements may be considerably relaxed when the intermediate images are kept off the optical elements.

The field lens may be arranged in a double pass region between the first intermediate image and the concave mirror. Positive refractive power between an upstream intermediate image and the concave mirror may reduce the numerical aperture in the part upstream of the concave mirror group and increases the geometrical distance from the folding mirrors to the concave mirror group, thereby facilitating installation and mounting

In some embodiments, the first intermediate image is located in the ylcinity of a deflecting mirror, which makes it possible to keep the design object field radius R_{DOF} small and therefore the Etendue of the system small. The field lens can generally be arranged very close to the intermediate image without being adversely affected by the folding mirror, thus allowing effective correction of imaging errors. In particular, the objective parts can be suitably designed in order to ensure that at least the intermediate image which is close to the field lens is subject to aberrations. This allows particularly effective correction of imaging aberration. The effectiveness of the correction can be assisted by designing at least one surface of the field lens as an aspherical surface. In some embodiments the aspherical surface may be the lens surface of the field lens which faces the intermediate image.

The field lens can be arranged such that it is arranged not only in the optical vicinity of an intermediate image plane which is located in the beam path upstream of the concave mirror, but also in the optical vicinity of an intermediate image plane which is located in the beam path down-stream from the concave mirror. This results in an arrangement close to the field with respect to two successive field surfaces, so that a powerful correction effect can be achieved at two points in the beam path.

In the case of reducing optical imaging, in particular of projection lithography, the image side numerical aperture NA is limited by the refractive index of the surrounding medium in image space. In immersion lithography the theoretically possible numerical aperture NA is limited by the refractive index of the immersion medium. The immersion medium can be a liquid or a solid. Solid immersion is also spoken of in the latter case.

However, for practical reasons the aperture should not come arbitrarily close to the refractive index of the last medium (i.e. the medium closest to the image), since the propagation angles then become very large relative to the optical axis. It has proven to be practical for the aperture not substantially to exceed approximately 95% of the refractive index of the last medium of the image side. This corresponds to maximum propagation angles of approximately 72° relative to the optical axis. For 193 nm, this corresponds to a numerical aperture of NA=1.35 in the case of water (n_{H2O}=1.43) as immersion medium.

With liquids whose refractive index is higher than that of the material of the last lens, or in the case of solid immersion, the material of the last lens element (i.e. the last optical element of the projection objective adjacent to the image) acts as a limitation if the design of the last end surface (exit surface of the projection objective) is to be planar or only weakly curved. The planar design is advantageous, for example, for measuring the distance between wafer and objective, for hydrodynamic behaviour of the immersion medium between the wafer to be exposed and the last objective surface, and for their cleaning. The last end surface must be of planar design for solid immersion, in particular, in order to expose the wafer, which is likewise planar.

For DUV (operating wavelength of 248 nm or 193 nm), the materials normally used for the last lens are fused silica (synthetic quartz glass, SiO₂) with a refractive index of n_{SIO2}=1.56 or CaF₂ with a refractive index of n_{CaF2}=1.50. The synthetic quartz glass material will also be referred to simply as “quartz” in the following. Because of the high radiation load in the last lens elements, at 193 nm calcium fluoride may be preferred for the last lens, in particular, since synthetic quartz glass may be damaged in the long term by the radiation load. This results in a numerical aperture of approximately 1.425 (95% of n=1.5) which can be achieved. If the disadvantage of the radiation damage is accepted, quartz glass still allows numerical apertures of 1.48 (corresponding to approximately 95% of the refractive index of quartz at 193 nm). The relationships are similar at 248 nm.

In some embodiments the projection objective has an image-side numerical aperture NA≧1.50. Embodiments may have NA=1.55 or higher, for example, i.e. NA≧1.55.

This may be achieved by providing that at least one optical element of the projection objective is a high-index optical element made from a high-index material with a refractive index n≧1.6 at the operating wavelength of the projection objective.

The high-index material may have a greater refractive index, for example n≧1.8 and/or n≧2.0 or higher

In some embodiments, the projection objective has an immersion lens group having a convex object-side entry surface bounding at a gas or vacuum and an image-side exit surface in contact with an immersion liquid in operation, wherein the immersion lens group is at least partly made of a high-index material with refractive index n≧1.6 at the operating wavelength. In this case, the image-side numerical aperture NA may be extended close to the refractive index of the high-index material in certain cases. The optical contact may be obtained by providing a physical contact at the mutually facing surfaces, e.g. by wringing. Cementing is an alternative. Another alternative is to provide a narrow gap between the facing surfaces, where the gap may be filled with air or another gas, or with an immersion liquid.

The immersion lens group may be a monolithic plano-convex lens made of the high-index material. In other embodiments, the immersion lens group includes at least two optical elements in optical contact with each other along a splitting interface, where at least one of the optical elements forming the immersion lens group consists of a high-index material with refractive index n≧1.6. Here, optical contact means that the rear (exit) surface of the first lens and the front (entry) surface of the second lens, facing each other, are either in mechanical contact with each other or with a small mechanical gap, either filled with gas or liquid or optical cement. Further degrees of freedom for the design may be obtained by using such a plano-convex composite immersion lens group.

The immersion lens group may form a last lens group closest to the image surface such that an exit side of the immersion lens group is directly adjacent to the image surface with no optical element in between. In other embodiments a substantially plane parallel plate immersed on both sides in the immersion liquid may be arranged between the immersion lens group and the image plane, such as shown, for example, in WO 2006/013734.

In some embodiments the immersion lens group includes a plano-convex composite lens having an image-side plano-convex second lens element having a curved entry surface and an essentially planar exit surface, and a meniscus shaped object-side first lens element having a curved entry surface and a curved exit surface in optical contact with the curved entry surface of the first lens element. A curved splitting surface, concave to the image-side, is obtained this way.

One advantage of using an immersion lens group with at least two lens elements is explained in the following. As explained above the immersion lens group preferably has at least one plano-convex lens element with high refractive index. High index materials are typically expensive and not available in large quantities and/or volumes. Therefore it may be desirable to minimize the quantity of high index material in the optical design. For this purpose an essentially powerless meniscus shell may be split from the front (entry side) surface of a high index lens, which splits the lens up in a shell lens and a thinner piano convex lens. The high index material of the meniscus shell lens may be replaced by a material of lower index, e.g. fused silica. In doing so, the required amount of high index material in an immersion lens group can be substantially reduced.

The first lens element may have a first refractive index n1 which is smaller than the second refractive index n2 of the second lens element such that the condition Δn≧0.08 holds for a refractive index difference Δn=n2−n1. A stepwise increase of refractive index in light propagation direction is thereby obtained close to the image surface.

In some embodiments the curved exit surface of the object-side first lens element has a curvature ρ₂, the curved entry surface of the image-side second lens element has a curvature ρ₃ and the condition L*|ρ₂−ρ₃|<5 holds. If this condition holds, an optional gap between the facing curved surfaces may have very small refractive power.

In some embodiments a gap between the curved exit surface of the object-side first lens element and the curved entry surface of the image-side second lens element is free of gas. The first and second lens element may be optically contacted by wringing or low temperature bonding or may be cemented together. However, problems due to differences in thermal expansion coefficients of the first and second lens element may arise at an interface formed by wringing. Therefore, in some embodiments, an immersion medium having refractive index n, is disposed in a gap between the exit surface of the first lens element and the entry surface of the second lens element, whereby these lens elements can be mechanically decoupled. Immersion liquids having a refractive index in the range 1.3≦n_{I}≦1.7 may be used for that purpose. A small gap width may be preferable such that a maximum gap width GW in the range 0.1 mm≦GW≦3 mm is obtained. Here, the gap width is defined for each point on the curved entry surface of the second lens element as the minimum distance to a corresponding point on the exit surface of the first lens element.

In some embodiments the curved entry surface of the object-side first lens element has a curvature ρ₁, the curved exit surface of the object-side first lens element has a curvature ρ₂ and the condition L*|ρ₁−ρ₂|<15 holds. If this condition holds, only little refractive power is provided by the region of the splitting surface.

Wherein the curved entry surface of the object-side first lens element has a curvature ρ₁, the curved exit surface of the object-side first lens element has a curvature ρ₂ and the condition L|ρ₁+ρ₂|>15 holds. A strong bending of the splitting surface according to this condition may be advantageous at very high image side NA.

A high-index crystalline material is preferably used for the second lens element positioned on the image-side, whereas the first lens element (on the object-side) is preferably made from a glassy material. The first lens element may be made of fused silica (SiO₂).

The high-index material may be chosen, for example, from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

Embodiments are configured to be operated with operating wavelenths in the deep ultraviolet (DUV) region, and the high-index material is transparent for ultraviolet radiation having a wavelength λ<260 nm, such as about 248 nm, or about 193 nm.

The previous and other properties can be seen not only in the claims but also in the description and the drawings, wherein individual characteristics may be used either alone or in sub-combinations as an embodiment of the invention and in other areas and may individually represent advantageous and patentable embodiments.

### BRIEF DESCRIPTION OF THE DRAWINGS

FIG. 1 shows a schematic drawing of an embodiment of a projection exposure apparatus for microlithography having an illumination system and a projection objective;

FIG. 2 shows a first embodiment of a catadioptric projection objective;

FIG. 3 shows a second embodiment of a catadioptric projection objective;

FIG. 4 shows a third embodiment of a catadioptric projection objective;

FIG. 5 shows a fourth embodiment of a catadioptric projection objective;

FIG. 6 shows a fifth embodiment of a catadioptric projection objective;

FIG. 7 shows a sixth embodiment of a catadioptric projection objective;

FIG. 8 shows a seventh embodiment of a catadioptric projection objective;

FIG. 9 shows a eighth embodiment of a catadioptric projection objective.

FIG. 10 shows a ninth embodiment of a catadioptric projection objective.

### DETAILED DESCRIPTION OF THE PREFERRED EMBODIMENTS

In the following description of preferred embodiments, the term “optical axis” refers to a straight line or a sequence of straight-line segments passing through the centers of curvature of optical elements. The optical axis can be folded by folding mirrors (deflecting mirrors) such that angles are included between subsequent straight-line segments of the optical axis. In the examples presented below, the object is a mask (reticle) bearing the pattern of a layer of an integrated circuit or some other pattern, for example, a grating pattern. The image of the object is projected onto a wafer serving as a substrate that is coated with a layer of photoresist, although other types of substrates, such as components of liquid-crystal displays or substrates for optical gratings, are also feasible.

Where tables are provided to disclose the specification of a design shown in a figure, the table or tables are designated by the same numbers as the respective figures. Corresponding features in the figures are designated with like or identical reference identifications to facilitate understanding. Where lenses are designated, an identification L3-2 denotes the second lens in the third objective part (when viewed in the radiation propagation direction).

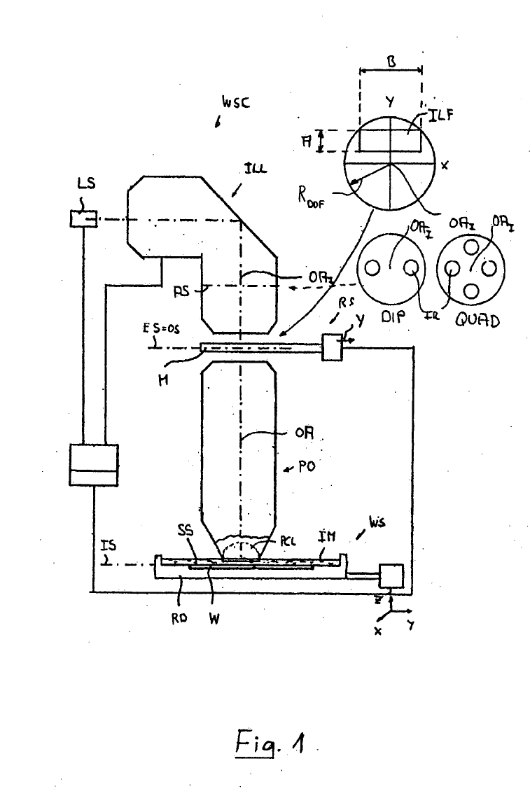

FIG. 1 shows schematically a microlithographic projection exposure system in the form of a wafer scanner WSC, which is provided for fabricating large scale integrated semiconductor components by means of immersion lithography in a step-and-scan mode. The projection exposure system comprises an Excimer laser as light source LS having an operating wavelength of 193 nm. Other operating wavelengths, for example 157 nm or 248 nm, are possible. A downstream illumination system ILL generates, in its exit surface ES, a large, sharply delimited, homogeneously illuminated illumination field ILF arranged off-axis with respect to the optical axis OA of the projection objective PO (which is coaxial with optical axis OA_{I} of the illumination system) and adapted to the telecentric requirements of the downstream catadioptric projection objective PO. The illumination system ILL has devices for selecting the illumination mode and, in the example, can be changed over between conventional on-axis illumination with a variable degree of coherence, and off-axis illumination, particularly annular illumination (having a ring shaped illuminated area in a pupil surface of the illumination system) and dipole or quadrupole illumination.

A device RS for holding and manipulating a mask M is arranged between the exit-side last optical element of the illumination system and the entrance of the projection objective such that a pattern—arranged on or provided by the mask—of a specific layer of the semiconductor component to be produced lies in the planar object surface OS (object plane) of the projection objective, said object plane coinciding with the exit plane EX of the illumination system. The device RS—usually referred to as “reticle stage” for holding and manipulating the mask contains a scanner drive enabling the mask to be moved parallel to the object surface OS of the projection objective or perpendicular to the optical axis (z direction) of projection objective and illumination system in a scanning direction (y-direction) for scanning operation.

The size and shape of the illumination field ILF provided by the illumination system determines the size and shape of the effective object field OF of the projection objective actually used for projecting an image of a pattern on a mask in the image surface of the projection objective. The slit-shaped illumination field ILF has a height A parallel to the scanning direction and a width B>A perpendicular to the scanning direction and may be rectangular (as shown in the inset figure) or arcuate (ring field). An aspect ratio B/A may be in a range from B/A=2 to B/A=10, for example. The same applies for the effective object field. A circle with minimum radius R_{DOF} around the effective object field and centred about the optical axis OA indicates the design object field including field points sufficiently corrected for aberrations to allow imaging with a specified performance. The effective object field includes a subset of those field points.

The reduction projection objective PO is telecentric at the object and image side and designed to image an image of a pattern provided by the mask with a reduced scale of 4:1 onto a wafer W coated with a photoresist layer. Other reduction scales, e.g. 5:1 or 8:1 are possible. The wafer W serving as a light-sensitive substrate is arranged in such a way that the planar substrate surface SS with the photoresist layer essentially coincides with the planar image surface IS of the projection objective. The wafer is held by a device WS (wafer stage) comprising a scanner drive in order to move the wafer synchronously with the mask M in parallel with the latter, and with reduced speed corresponding to the reduction ratio of the projection objective. The device WS also comprises manipulators in order to move the wafer both in the Z direction parallel to the optical axis OA and in the X and Y directions perpendicular to said axis. A tilting device having at least one tilting axis running perpendicular to the optical axis is integrated.

The device WS provided for holding the wafer W (wafer stage) is constructed for use in immersion lithography. It comprises a receptacle device RD, which can be moved by a scanner drive and the bottom of which has a flat recess for receiving the wafer W. A peripheral edge forms a flat, upwardly open, liquidtight receptacle for a liquid immersion medium IM, which can be introduced into the receptacle and discharged from the latter by means of devices that are not shown. The height of the edge is dimensioned in such a way that the immersion medium that has been filled in can completely cover the surface SS of the wafer W and the exit-side end region of the projection objective PO can dip into the immersion liquid given a correctly set operating distance between objective exit and wafer surface. Other methods for providing an immersion fluid layer, such as local filling, are also possible.

The projection objective PO has an immersion lens group formed by a piano-convex lens PCL, which is the last optical element nearest to the image surface IS. The planar exit surface of said lens is the last optical surface of the projection objective PO. During operation of the projection exposure system, the exit surface of the piano-convex lens PCL is partly or completely immersed in the immersion liquid IM and is wetted by the latter. In the exemplary case the immersion liquid has a refractive index n_{I}≈1.65 at 193 nm. The convex entry surface of plano-convex lens PCL is adjacent to a gas filling the space between this lens and a lens immediately upstream thereof on the object-side. The plano-convex lens forms a monolithic immersion lens group allowing the projection objective to operate at NA>1 in an immersion operation.

In this application, the term “immersion lens group” is used for a single lens or a lens group including at least two cooperating optical elements providing a convex object-side entry surface bounding at a gas or vacuum and an image-side exit surface in contact with an immersion liquid in operation. The exit surface may be essentially planar. The immersion lens group guides the rays of the radiation beam from gas (or vacuum) into the immersion liquid.

Various different illumination settings may be set with the illumination system ILL. For example, where the pattern of the mask to be projected on the wafer essentially consists of parallel lines running in one direction, a dipole setting DIP (see left inset figure) may be utilized to increase resolution and depth of focus. To this end, adjustable optical elements in the illumination system are adjusted to obtain, in a pupil surface PS of the illumination system ILL, an intensity distribution characterized by two locally concentrated illuminated regions IR of large light intensity at diametrically opposed positions outside the optical axis OA and little or no light intensity on the optical axis. A similar inhomogeneous intensity distribution is obtained in pupil surfaces of the projection objective optically conjugate to the pupil surface of the illumination system.

The illumination setting may be changed to obtain, for example, conventional illumination (rotational symmetry around the optical axis) or quadrupole illumination (four-fold radial symmetry around the optical axis, see right hand side inset figure QUAD with four off-axis illuminated regions IR).

Illumination systems capable of optionally providing the described off-axis polar illumination modes are described, for example, in U.S. Pat. No. 6,252,647 B1 or in applicant's patent application US 2006/005026 A1, the disclosure of which is incorporated herein by reference.

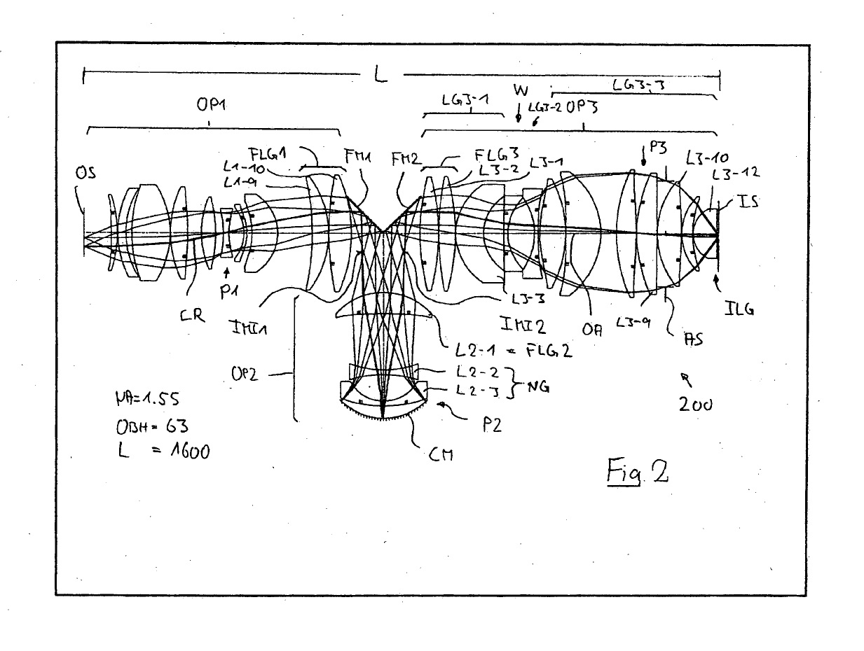

FIG. 2 shows a catadioptric projection objective 200 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1600 mm. The radius R_{DOF} of the design object field, also denoted object field height OBH, is 63 mm. The specification is given in tables 2, 2A.

Projection objective 200 is designed to project an image of a pattern on a reticle arranged in the planar object surface OS (object plane) into the planar image surface IS (image plane) on a reduced scale while creating exactly two real intermediate images IMI1, IMI2. The rectangular effective object field OF and image field IF are off-axis, i.e. entirely outside the optical axis OA. A first refractive objective part OP1 is designed for imaging the pattern provided in the object surface into the first intermediate image IMI1. A second, catadioptric (refractive/reflective) objective part OP2 images the first intermediate image IMI1 into the second intermediate image IMI2 at a magnification close to 1:(−1). A third, refractive objective part OP3 images the second intermediate image IMI2 onto the image surface IS with a strong reduction ratio.

Projection objective 200 is an example of a “concatenated” projection objective having a plurality of cascaded objective parts which are each configured as imaging systems and are linked via intermediate images, the image (intermediate image) generated by a preceding imaging system in the radiation path serving as object for the succeeding imaging system in the radiation path. The succeeding imaging system can generate a further intermediate image (as in the case of the second objective part OP2) or forms the last imaging system of the projection objective, which generates the “final” image field in the image plane of the projection objective (like the third objective part OP3). Systems of the type shown in FIG. 2 are sometimes referred to as R—C—R system, where “R” denotes a refractive imaging system and “C” denotes a catadioptric (or catoptric) imaging system.

The path of the chief ray CR of an outer field point of the off-axis object field OF is drawn bold in FIG. 2 in order to facilitate following the beam path of the projection beam. For the purpose of this application, the term “chief ray” (also known as principal ray) denotes a ray running from an outermost field point (farthest away from the optical axis) of the effectively used object field OF to the center of the entrance pupil. Due to the rotational symmetry of the system the chief ray may be chosen from an equivalent field point in the meridional plane. In projection objectives being essentially telecentric on the object side, the chief ray emanates from the object surface parallel or at a very small angle with respect to the optical axis. The imaging process is further characterized by the trajectory of marginal rays. A “marginal ray” as used herein is a ray running from an axial object field point (field point on the optical axis) to the edge of an aperture stop. That marginal ray may not contribute to image formation due to vignetting when an off-axis effective object field is used. The chief ray and marginal ray are chosen to characterize optical properties of the projection objectives. The radial distance between such selected rays and the optical axis at a given axial position are denoted as “chief ray height” (CRH) and “marginal ray height” (MRH), respectively. In so far as reference is made to a “marginal ray height” (MRH) or a “chief ray height” (CRH) in this application, this is taken to mean the paraxial marginal ray height and the paraxial chief ray height. The angle included between the chief ray and the optical axis is the chief ray angle CRA. The angle included between the marginal ray and the optical axis is the marginal ray angle MRA.

Three mutually conjugated pupil surfaces P1, P2 and P3 are formed at positions where the chief ray CR, being substantially telecentric in image space, intersects the optical axis. A first pupil surface P1 is formed in the first objective part between object surface and first intermediate image, a second pupil surface P2 is formed in the second objective part between first and second intermediate image, and a third pupil surface P3 is formed in the third objective part between second intermediate image and the image surface IS.

The second objective part OP2 includes a single concave mirror CM situated at the second pupil surface P2. A first planar folding mirror FM1 is arranged optically close to the first intermediate image IMI1 at an angle of 45° to the optical axis OA such that it reflects the radiation coming from the object surface in the direction of the concave mirror CM. A second folding mirror FM2, having a planar mirror surface aligned at right angles to the planar mirror surface of the first folding mirror, reflects the radiation coming from the concave mirror CM in the direction of the image surface, which is parallel to the object surface. The folding mirrors FM1, FM2 are each located in the optical vicinity of, but at a small distance from the closest intermediate image. A double pass region where the radiation passes twice in opposite directions is formed geometrically between the deflecting mirrors FM1, FM2 and the concave mirror CM.

The projection objective includes two negative meniscus lenses forming a negative group NG immediately in front of the concave mirror CM and coaxial with the concave mirror and passed twice by radiation on its way from first folding mirror FM1 towards the concave mirror, and from the concave mirror towards the second folding mirror FM2. A combination of a concave mirror arranged at or optically close to a pupil surface and a negative group comprising at least one negative lens arranged in front of the concave mirror on a reflecting side thereof in a double pass region such that radiation passes at least twice in opposite directions through the negative group is sometimes referred to as “Schupmann achromat”. This group contributes significantly to correction of chromatic aberrations, particularly axial chromatic aberration. Correction of Petzval sum is predominantly influenced by the curvature of concave mirror CM.

First objective part OP1 generating the first intermediate image IMI1 includes ten lenses and the first planar folding mirror FM1 immediately upstream of the first intermediate image IMI1. The lenses include positive meniscus lens L1-9 concave on the entry side, and biconvex positive lens L1-10 immediately upstream of the first folding mirror FM1 and first intermediate image IMI1 in a region where the height of the chief ray CR is about equal or lager than the height of the marginal ray, indicating that these positive lenses are optically close to the first intermediate image IMI1. Lenses L1-9 and L1-10 form a positive first field lens group FLG1 effective to provide an essentially telecentric first intermediate image IMI1 such that the chief ray is almost parallel to the optical axis on and downstream of the first folding mirror FM1 (chief ray angle<15°).

A single positive meniscus lens L2-1 is arranged in the double pass region geometrically close to the folding mirrors FM1, FM2 and optically close to both the first and second intermediate images, thereby acting as a positive second field lens group FLG2. The slightly concave lens surface facing the concave mirror is aspheric. Positive field lens L2-1 is effective to converge incident radiation towards the concave mirror CM and radiation reflected from the concave mirror is converged towards second intermediate image IMI2 such that the chief ray is almost parallel to the optical axis between lens L2-1 and second folding mirror FM2 downstream of the second intermediate image IMI2 (chief ray angle<15°.

Two biconvex positive lenses L3-1 and L3-2 are positioned immediately downstream of the second intermediate image IMI2 and the second folding mirror FM2 in a region where the chief ray height is larger than the marginal height, thereby acting as positive third field lens group FLG3 close to the second intermediate image IMI2 to converge the beam towards a third pupil surface P3.

A primary task of the first and second field lens groups FLG1 and FLG2 is to image the first pupil plane in the first dioptric system OP1 into the second pupil plane next to the concave mirror in the second subsystem OP2. A primary task of the second and third field lens groups FLG2 and FLG3 is to image the second pupil plane next to the concave mirror into the third pupil plane in the second dioptric system OP3.

Field lenses L3-1 and L3-2 together with a subsequent positive meniscus lens L3-3 concave on the image-side form a first lens group LG3-1 with positive refractive power, followed by a negative lens group with negative refractive power including two negative lenses, and a subsequent positive lens group LG3-3 including seven positive lenses to converge the radiation towards the image surface IS. A waist W characterized by a local minimum of beam diameter with diameter D₂ is formed between the positive lens groups LG3-1 and LG3-3. The maximum diameter in the region of field lenses L3-1 and L3-2 is D₁. A diameter ratio A D₁/D₂ is lager than 1.3 indicating a pronounced waist in the third objective part.

A variable aperture stop AS is arranged close to the third pupil surface P3 in a region of convergent beam between positive lens L3-9 and L3-10. The pupil surface is determined by the fact that the image plane is essentially telecentric. The aperture stop AS is positioned in a region axially displaced from the chief ray intersection with the optical axis towards the image surface. Under these conditions it may be advantageous to design the aperture stop such that it has an aperture stop edge determining the aperture stop diameter, where the axial position of the aperture edge with reference to the optical axis is varied as a function of the aperture stop diameter. This permits optimum adaptation of the effective aperture stop position to the beam path as a function of the aperture stop diameter. For example, the aperture stop may be configured as a spherical aperture stop in which the aperture stop edge can be moved along a spherical surface during adjustment of the aperture stop diameter. In particular, the aperture stop edge may be moved on a spherical surface which is concave to the image side when the aperture stop diameter is decreased. Alternatively, the aperture stop may be designed as a conical aperture stop in which the aperture stop edge can be moved on a lateral surface of the cone during adjustment of the aperture stop diameter. This can be achieved, for example, by providing a planar aperture stop and a device for axially displacing the planar aperture stop as the aperture diameter is varied.

The image-side end of the projection objective is formed by a plano-convex positive lens L3-12 acting as an immersion lens group ILG to guide the radiation rays from gas-filled space upstream of the convex entry surface of the piano-convex lens into the immersion liquid which fills the image-side working space between the planar exit surface of the piano-convex lens and the image surface during operation. Plano-convex lens L3-12 is made of ceramic magnesium aluminium oxide (MgAlO₄), also denoted as spinel, having a refractive index n≈1.92 at λ=193 nm. All other lenses are made of fused silica with n≈1.56 at λ=193 nm.

The optical powers of lenses upstream and downstream of the intermediate images and the folding mirrors FM1, FM2 are balanced in such a way that rays originating from a common field point in the object surface at different aperture angles do not intersect on one of the lens surfaces of the field lens groups upstream or downstream of the intermediate images, and do not intersect on each one of the folding mirrors FM1, FM2. With other words, this embodiment is optimized to avoid caustic conditions on optical surfaces close to the intermediate images IMI1, IMI2. In doing so, surface and volume purity specifications may be relaxed. Thus, the embodiment may be less susceptible to image deterioration due to the effect of dirt or other imperfections on optical surfaces and in lenses close to the intermediate images. This may be understood as follows. In terms of ray propagation, a caustic condition is given on an optical surface if different rays emitted from an object field point at different numerical aperture intersect on the optical surface or in the vicinity thereof. A surface imperfection (such as a scratch or a dirt particle) on an optical surface positioned in a caustic region may therefore stop (or mask out) a large region of rays in the pupil coordinates space, therefore having a large impact on the image forming interferences, especially with coherent illumination settings of small relative aperture. This may potentially deteriorate imaging quality substantially more than an imperfection positioned outside a caustic region.

The absence of caustic conditions at the folding mirrors FM1, FM2 and adjacent lens surfaces of the field lens groups FLG1 and FLG3 corresponds to the fact that rays of ray bundles originating from different field points (FIG. 2 shows only some rays of two representative ray bundles) intersect in a very narrow region to form the intermediate images IMI1, IMI2, which correspondingly are rather well corrected for certain aberrations, such as spherical aberration and coma.

As will be apparent from the discussion of further embodiments below, the existence or absence of caustic conditions near the intermediate images as well as the distribution of optical power in field lenses or lens groups close to the intermediate images may be varied to find an optimum balance between imaging properties and geometrical constraints in terms of desired track length and other characteristics, such as the distance of the concave mirror from the folding mirrors.

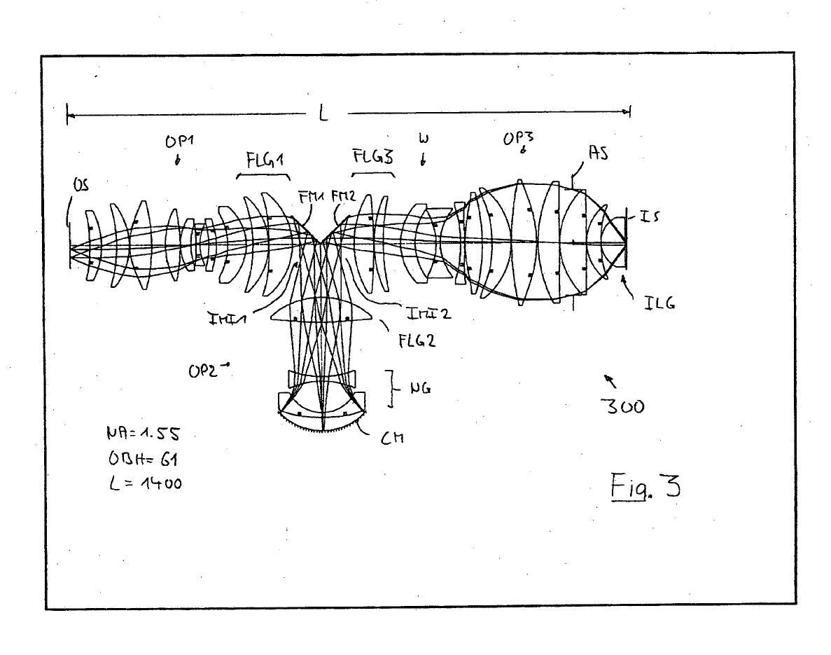

FIG. 3 shows a catadioptric projection objective 300 designed for a nominal UV-operating wavelength λ 193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1400 mm. The radius R_{DOF} of the design object field, also denoted object field height OBH, is 61 mm. The specification is given in tables 3, 3A.

Some characterizing features are now discussed in relation to the embodiment of FIG. 2. In general, projection objective 300 is even more compact in axial and radial dimensions than the embodiment of FIG. 2, which may be indicated particularly by the smaller track length (L=1400 mm) and the smaller object height (OBH=61 mm) at the same numerical aperture NA=1.55. The size reduction is partly made possible by by the fact that the intersection point of the chief ray and the rim ray of the outermost field point approaches more and more the first field lens group FLG1 and thus gives raise to caustics on the first folding mirror FM1. Keeping the chief ray height at FLG1 constant and allowing caustic conditions at the first field lens group FLG1 allows the marginal ray of the outermost field point to have a smaller height. This reduces the required semidiameter of first field lens group FLG1, which is predominantly determined by the height of the marginal ray at the lens. As the refractive power of the lens group stays constant, smaller field lens group lenses may also have smaller center thicknesses and thus lead to an axially more compact field lens group. This finally enables to shorten the overall system length.

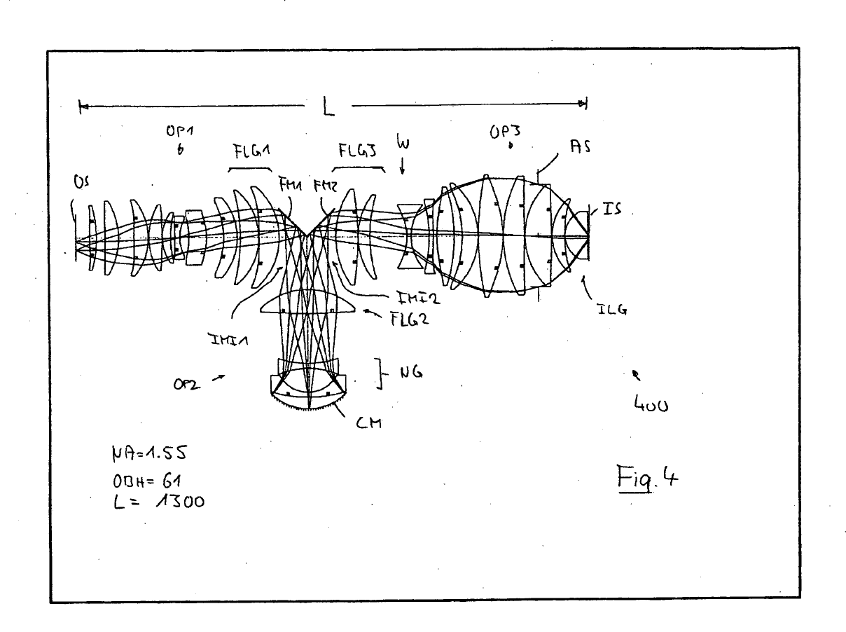

FIG. 4 shows a catadioptric projection objective 400 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1300 mm. The radius R_{DOF} of the design object field, also denoted object field height OBH, is 61 mm. The specification is given in tables 4, 4A.

Catadioptric projection objective 400 may be used as an example to demonstrate that a further reduction in track length L as well as in diameters of the field lenses FLG1, FLG3 in the refractive objective parts may be obtained if caustic conditions are allowed not only on the folding mirrors FM1, FM2, but also on the lens surfaces of field lenses immediately upstream of the first folding mirror FM1 or immediately down-stream of the second folding mirror FM2.

As discussed in connection with the above embodiments, a positive field lens FLG2 in a double-pass region between the folding mirrors FM1, FM2 and the concave mirror may contribute substantially to configure projection objectives of the folded type having a relatively moderate track length even at very high image-side NA. However, such a positive field lens is generally not mandatory, as exemplarily shown in the following embodiment.

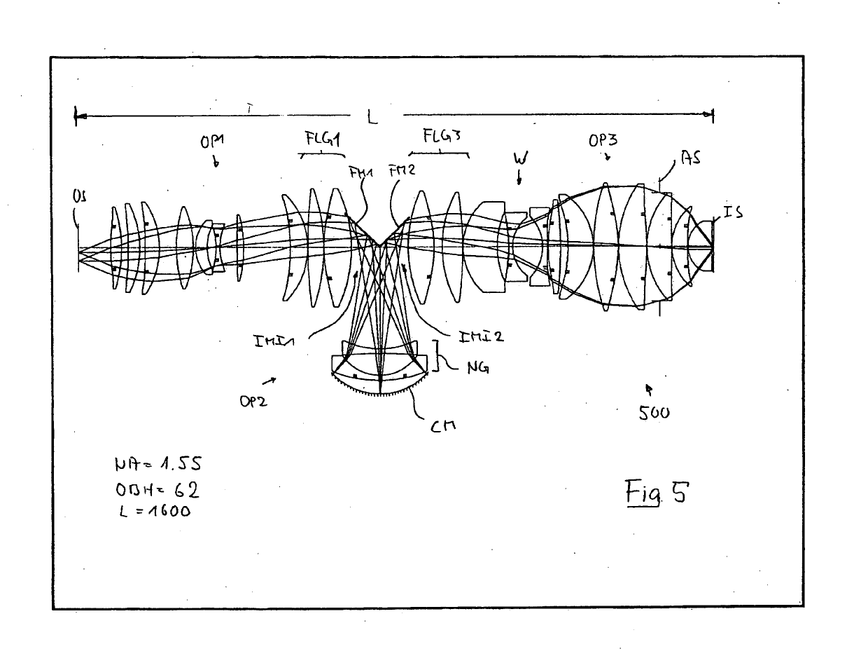

FIG. 5 shows a catadioptric projection objective 500 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1600 mm. The radius R_{DOF} of the design object field, also denoted object field height OBH, is 62 mm. The specification is given in tables 5, 5A.

If no positive refractive power is provided in the double pass region between the folding mirrors and the concave mirror, it is generally difficult to provide substantially telecentric intermediate images with a concave mirror positioned at a pupil position in the second objective part. With the absence of a double-pass positive field lens in the second objective part, the refractive power of the first and third field lens groups FLG1, FLG3 increase each by the refractive power of the missing second FLG2 in order to provide the imaging of the first to the third pupil plane. Thus, as a consequence, the lenses providing the positive first field lens group FLG1 at the end of the first objective part OP1, and the lenses constituting the positive field lens group FLG3 on the entry-side of the third objective part OP3 tend to become larger in diameter and have an increased thickness as compared to corresponding lenses in systems with a double-pass positive field lens in the second objective part. This tends to drive the overall system track length up. At the same time, caustic conditions are given on both folding mirrors FM1, FM2. Also, caustic conditions are given on the lens surfaces of the positive field lens groups closest to the folding mirrors. Further, the geometrical mechanical free distance between the outer edge of the large positive lenses of the field lens groups FLG1, FLG3 upstream and downstream of the intermediate images and the concave mirror CM decreases when compared to the embodiments with double-pass positive field lens, which may require additional outlay with regard to mounting technology.

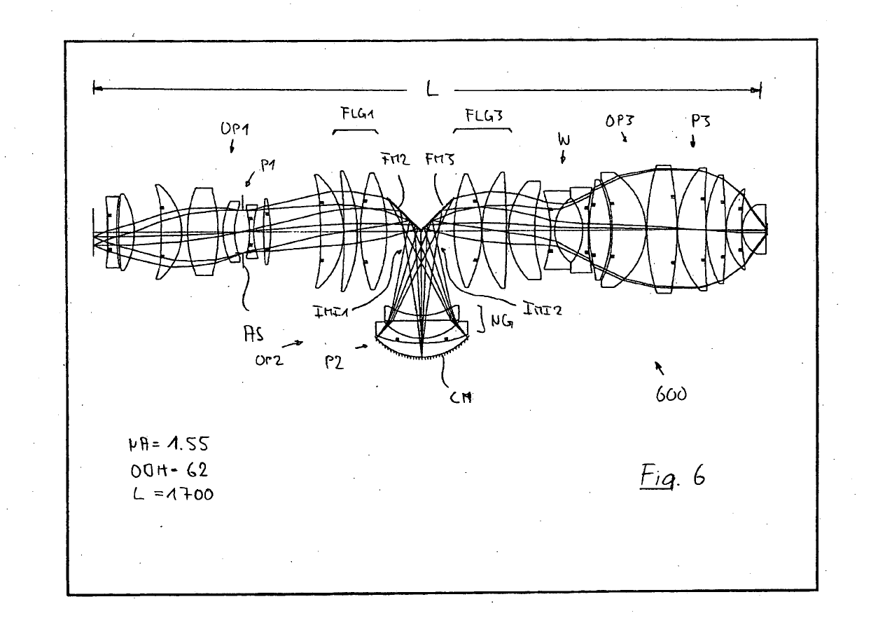

FIG. 6 shows a catadioptric projection objective 600 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1700 mm. The radius R_{DOF} of the design object field, also denoted object field height OBH, is 62 mm. The specification is given in tables 6, 6A.

A comparison of the features of exemplary embodiments in FIGS. 5 and 6 reveals that the embodiment of FIG. 6 has been designed to avoid caustic conditions on the lens surfaces of positive field lens groups upstream of the first folding mirror and downstream of the second folding mirror. Without further measures (such as introducing a double-pass positive field lens in the second objective part) this requirement tends to increase the track length L in comparison to the system of FIG. 5 allowing caustic conditions on the field lenses.

Differing from the embodiments discussed above, the variable aperture stop AS is positioned in the first objective part OP1 at the first pupil surface P1. In this embodiment, the variable aperture stop AS may be configured as a planar aperture stop having a relatively simple construction. A variable aperture stop in the first objective part may also be provided in the embodiments discussed above and below instead of a variable aperture stop in the third objective part.

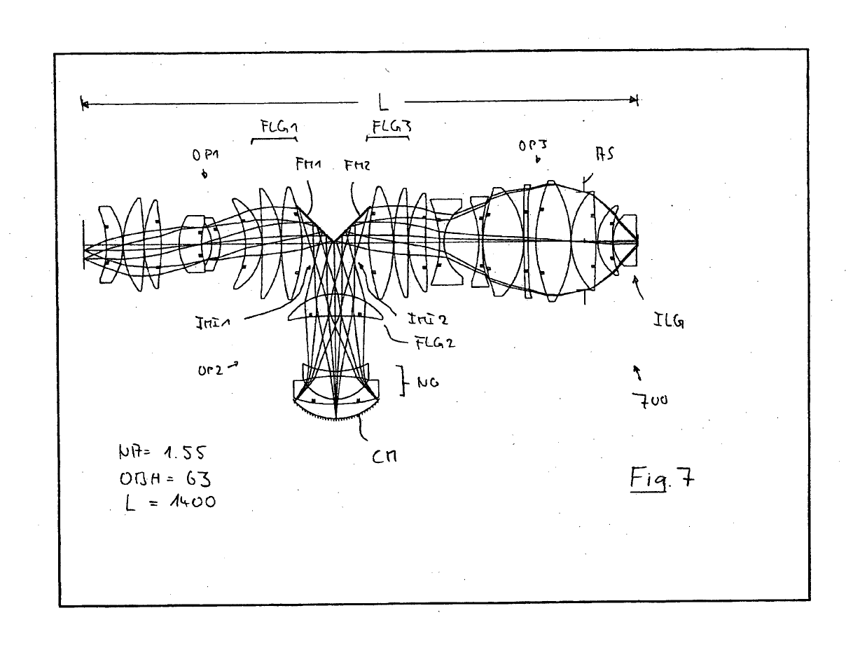

FIG. 7 shows a catadioptric projection objective 700 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1400 mm. The radius R_{DOF} of the design object field, also denoted object field height OBH, is 63 mm. The specification is given in tables 7, 7A.

A variety of high-index materials may be used to design the immersion lens group ILG, which is formed by a single, monolithic plano-convex lens in the exemplary embodiments discussed above. While in those embodiments the piano-convex lens is made of spinel (n≈1.92), the embodiment of FIG. 7 is characterized by an immersion lens group ILG formed by a single, monolithic piano-convex lens made of lutetium aluminum garnet (LuAG) having n=2.14 at λ=193 nm. The relatively small track length (L=1400 mm) indicates that the higher refractive index used in the immersion length group may be utilized to make the systems more compact in the axial direction. Both the first intermediate image IMI1 and the second intermediate image IMI2 are very well corrected such that both folding mirrors FM1, FM2 and the lens surfaces of the field lenses FLG1 upstream and FLG3 downstream of the folding mirrors are in caustic-free regions. Regarding this aspect, the embodiment of FIG. 7 may be compared to the embodiment of FIG. 2, where also no caustic conditions are given at the folding mirrors and the adjacent lens surfaces.

Other high-index materials may be used in other embodiments. In general, the high-index material, used for a plano-convex lens element in the above embodiments, may be chosen, for example, from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

The image-side numerical aperture NA is typically limited by the refractive index of material in the immersion lens group responsible for guiding the convergent rays at the image-side end of the projection objective from a gas-filled space (or vacuum) within the projection objective into an immersion medium with refractive index much larger than 1, such as an immersion liquid. Where the exit-side of the immersion lens group is essentially planar, the image-side NA cannot exceed the refractive index of the material adjacent to the exit surface. As used here, the term “essentially planar” includes mathematically planar surfaces as well as surfaces having a very weak curvature, typically with a radius of curvature larger than 300 mm, or larger than 500 mm, or larger than 1000 mm, or larger than 5000 mm, for example. It is desirable to use high index materials in the immersion lens group, wherein a high-index material has a refractive index at the operating wavelength which is larger than the refractive index of other lenses within the projection objective. In the case of projection objectives for an operating wavelength λ=193 nm, the other lenses are typically made of fused silica (n≈1.56), optionally with one or more lens made of calcium fluoride (n≈1.50 at 193 nm). Consequently, high-index materials suitable for this purpose have n≧1.6 at 193 nm, preferably n≧1.8 or n≧1.9 or n≧2.0, for example. Suitable crystalline high-index materials include spinell with n≈1.92 or lutetium aluminium garnet (LuAG) with n≈2.14 at 193 nm, as exemplarily shown in the above embodiments.

High index materials suitable for lithographic applications are currently in limited supply, and further research and development is still in progress. Potentially suitable materials are expensive and often have undesirable properties, such as birefringence, increased absorption and/or increased density of a scattering centers within the material, which are generally undesirable properties in a material for a lens in a lithographic application. It is therefore desirable to limit the amount of high-index materials necessary to obtain a required high NA value. In the following examples, measures to reduce the amount (volume) of high index material are described, particularly measures to reduce the axial thickness of optical elements of high index material in the immersion lens group.

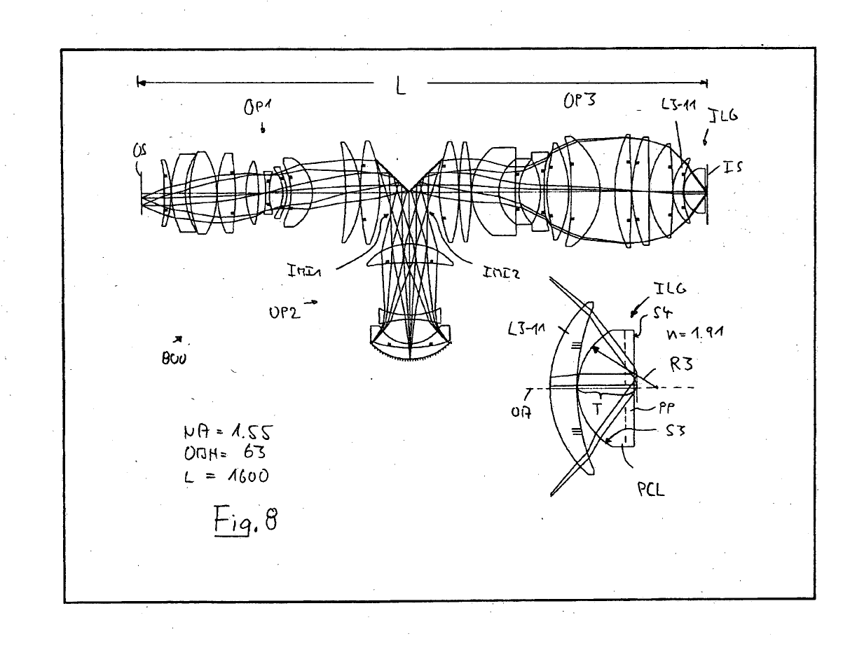

FIG. 8 shows an embodiment of a catadioptric projection objective 800 similar in design to the projection objective 200 of FIG. 2. Reference is therefore made to the corresponding description regarding the sequence and types of lenses and objective parts. Objective 800 is designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1600 mm. The radius R_{DOF} of the design object field, also denoted object field height OBH, is 63 mm. The specification is given in tables 8, 8A.

All lenses, with the exception of the piano-convex lens PCL forming the last optical element adjacent to the image surface, are made of fused silica. Piano-convex lens PCL forming the immersion lens group is made of spinel (n≈1.92).

A dashed line perpendicular to the optical axis OA indicates that a plane-parallel plate PP may be separated from the lens such that the lens is a composite lens including a planar splitting surface. A small gap filled with immersion liquid may be provided in operation between the remaining plano-convex lens element and the parallel plate PP.

The plano-convex lens PCL has a thickness T (distance between convex entry surface S3 and planar exit surface S4 along the optical axis) of T=60 mm and a radius of curvature, R3, of the convex entry surface S3 which is larger than the thickness (R3=60 mm) such that the center of curvature of convex entry surface S3 lies beyond the image surface.

Measures will now be described to reduce the thickness of the high-index material piano-convex lens in the immersion lens group ILG.

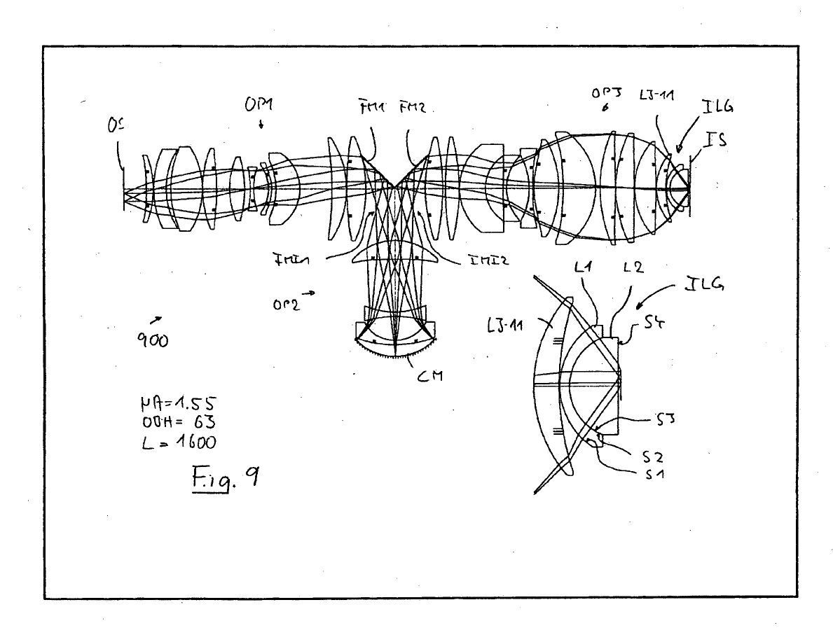

FIG. 9 shows a catadioptric projection objective 900 having basically the same optical properties and lens construction as the embodiment of FIG. 8, with the exception at the image side end where the immersion lens group ILG is situated. The specification is given in Tables 9, 9A.

In contradistinction to the embodiment of FIG. 8, the immersion lens group ILG is formed by a plano-convex composite lens having an image-side plano-convex second lens element L2 made of spinel having a convex entry surface S3 and an essentially planar exit surface S4 forming the exit surface of the projection objective, and a meniscus-shaped object-side first lens element L1 made of fused silica and having a convexly curved entry surface S1 and a concave exit surface S2 in optical and mechanical contact with the convex entry surface S3 of the first lens element L1. First and second lens elements L1, L2 may be contacted by wringing, or cementing, or low-temperature bonding in this embodiment to provide that no air space is formed at the curved splitting surface S2/S3 between L1 and L2. Although the glassy material of fused silica first lens element L1 has a refractive index n≈1.56 smaller than the refractive index n≈1.92 of the high-index material of second lens element L2, the overall effect of the composite plano-convex immersion lens group is similar to the optical effect of the thicker monolithic plano-convex lens PCL in FIG. 8. In contradistinction to this embodiment, the thickness of piano-convex high-index second lens element L2 is only 52 mm, which is about 13% smaller than the thickness of the monolithic piano-convex PCL (T=60 mm) in FIG. 8. This example shows that the consumption of high-index material can be reduced while generally maintaining the optical performance, if a composite immersion lens group is employed.

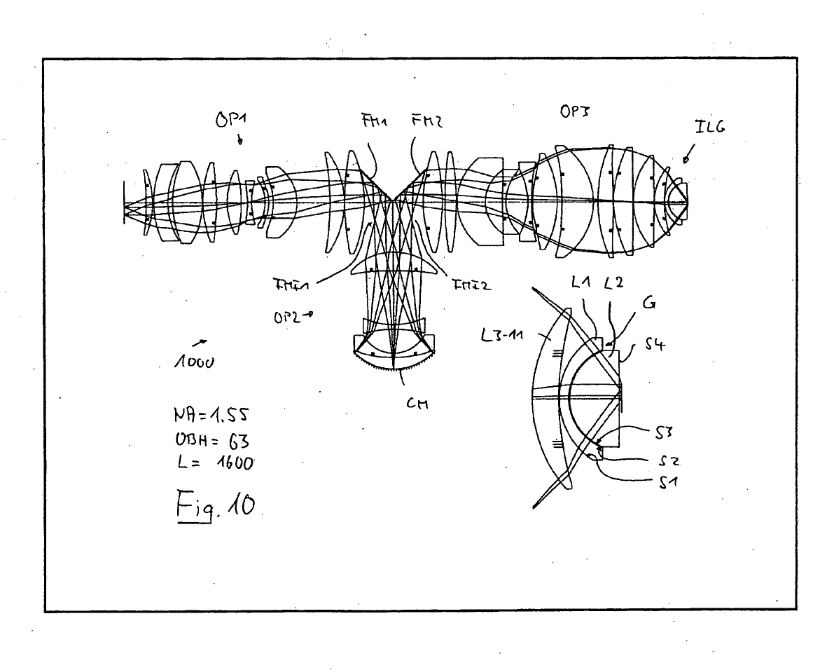

FIG. 10 shows a catadioptric projection objective 1000, which is a variant of the embodiment of FIG. 9 basically differing only in the construction of the immersion lens group ILG directly adjacent to the image surface IS. The specification is given in Tables 10, 10A.

In this embodiment, a small curved gap G is formed between the concave exit surface S2 of object-side first lens element L1 and the convex entry surface of second lens element L2, the gap being filled with gas and having a gap width in the order of 1 mm, where the gap width is defined here for each point of the curved entry surface of the second lens element as the minimum distance to a corresponding point on the concave exit surface of the first lens element. Providing such gap allows to reduce potential problems which might arise due to a difference in thermal expansion between the glassy material of the first lens element L1 and the crystalline material of second lens element L2, which are separately mounted in this embodiment.

In other embodiments, the gap G between the first and second lens elements L1, L2 of the immersion lens group is filled with an immersion liquid mediating the transition of rays between the solid materials bounding the gap.

It has been found that it may be preferable to observe certain conditions for the curvatures (reciprocal of the radius R of curvature) of the curved lens surfaces in the immersion lens group. For example, where the curved exit surface of the object-side first lens element has a curvature ρ₂ and the curved entry surface of the image-side second lens element has a curvature ρ₃, the condition L*|ρ₂−ρ₃|<5 may be observed. If this condition holds, an optional gap between the facing curved surfaces may have very small refractive power. Where the curved entry surface of the object-side first lens element has a curvature ρ₁, and the curved exit surface of the object-side first lens element has a curvature ρ₂ and the condition L*|ρ₁−ρ₂|<15 may be observed. If this condition holds, only little refractive power is provided by the region of the splitting surface S2/S2. If the condition L*|ρ₁+ρ₂|>15 holds, a strong bending of the splitting surface is given, which may be advantageous at very high image side NA.

The following Table A provides an overview over some characteristic features of the exemplary embodiments discussed above. In the table, A=D₁/D₂ indicates the diameter ratio between the maximum diameter D₁ of the first, positive lens group of the third objective part, and the minimum diameter in the waist region following the first positive lens group, OBH designates the object height (also denoted as design object field radius R_{DOF}) in [mm], L designates the track length (geometrical distance between the object surface and the image surface), β designates the absolute magnification ratio, and dimensionless parameter B indicates the relation between track length and object height.

TABLE A

| | FIG. | | | | | | | | |
|---|---|---|---|---|---|---|---|---|---|
| | 2 | 3 | 4 | 5 | 6 | 7 | 8 | 9 | 10 |
| A | 1.63 | 1.45 | 1.57 | 1.97 | 1.81 | 1.63 | 1.62 | 1.64 | 1.65 |
| OBH [mm] | 63 | 61 | 61 | 62 | 62 | 63 | 63 | 63 | 63 |
| L [mm] | 1600 | 1400 | 1300 | 1600 | 1700 | 1400 | 1600 | 1600 | 1600 |
| β | 0.25 | 0.25 | 0.25 | 0.25 | 0.25 | 0.25 | 0.25 | 0.25 | 0.25 |
| B = \|L/(OBH * β)\| | 101.6 | 92.0 | 85.2 | 103.2 | 109.8 | 88.8 | 101.6 | 101.6 | 101.6 |

Table B below summarizes some parameters characterizing the properties of the immersion lens groups in the embodiments of FIGS. 9 and 10 (composite immersion lens groups). In the table, R1, R2 and R3 indicate the respective radii of curvature in [mm] of the respective lens surfaces S1, S2, S3, and ρ₁, ρ₂, ρ₃ indicate the curvatures in [mm⁻¹].

TABLE B

FIG.

| | 9 | 10 |
|---|---|---|
| L | 1600 | 1600 |
| R1 | 80.017 | 81.56 |
| R2 | 57.068 | 58.494 |
| R3 | 57.068 | 57.175 |
| L * \|ρ₂ − ρ₃\| | 0 | 0.6 |
| L * \|ρ₁ − ρ₂\| | 8.0 | 7.7 |
| L * \|ρ₁ + ρ₂\| | 48.0 | 47.0 |

The particular technical measures explained in connection with FIGS. 8 to 10 to reduce the amount of high-index material required to form an immersion lens group may be used not only in catadioptric projection objectives of the folding geometry described in detail in this application. Instead, those features may also be implemented in other types of projection objectives independent of the folding geometry and/or independent of the presence or absence of folding mirrors. For example, composite immersion lens groups may also be used in projection objectives generally described, for example in U.S. Pat. No. 6,995,833 B2, for example where a first folding mirror is arranged optically downstream of the concave mirror to deflect radiation reflected from the concave mirror towards the second folding mirror. The measures may also be employed in catadioptric in-line projection objectives having one straight optical axis common to all optical elements, such as shown, for example, in WO 2005/069055 A. The disclosure of these documents is incorporated herein by reference.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof. The content of all the claims is made part of this description by reference.

The following tables summarize specifications of embodiments described above. In the tables, column 1 specifies the number of a refractive surface or a reflective surface or a surface distinguished in some other way, column 2 specifies the radius r (radius of curvature) of the surface (in mm), column 3 specifies the distance d—also denoted as thickness—between the surface and the subsequent surface (in mm), and column 4 specifies the material of the optical components. Column 5 indicates the refractive index of the material, and column 6 specifies the optically free radius or the optically free semidiameter (or the lens height) of a lens surface or other surfaces (in mm). Radius r=0 corresponds to a planar surface.

The table or tables are designated by the same numbers as the respective figures. A table with additional designation “A” specifies the corresponding aspheric or other relevant data. The aspheric surfaces are calculated according to the following specification:

p(h)=[((1/r)h²)/(1+SQRT(1−(1+K)(1/r)²h²))]+C1*h⁴+C2*h⁶+ . . .

In this case, the reciprocal (1/r) of the radius specifies the surface curvature and h specifies the distance between a surface point and the optical axis (i.e. the ray height). Consequently, p(h) specifies the so-called sagitta, that is to say the distance between the surface point and the surface vertex in the z direction (direction of the optical axis). Constant K is the conic constant, and parameters, C1, C2 are aspheric constants.

TABLE 2

| NA | 1.55 | | | | |
|---|---|---|---|---|---|
| OBH | 63 | THICK- | MA- | | SEMI- |
| SURF | RADIUS | NESS | TERIAL | INDEX | DIAM. |
| 0 | 0.000000 | 69.339615 | | | 63.0 |
| 1 | −4592.991859 | 16.322295 | SIO2 | 1.560482 | 137.5 |
| 2 | −309.895506 | 1.240650 | | | 172.4 |
| 3 | 247.334097 | 20.337551 | SIO2 | 1.560482 | 186.5 |
| 4 | 207.125297 | 15.538300 | | | 123.9 |
| 5 | 319.478942 | 98.435900 | SIO2 | 1.560482 | 123.0 |
| 6 | −236.591216 | 1.081577 | | | 131.0 |
| 7 | 271.627798 | 44.314798 | SIO2 | 1.560482 | 136.7 |
| 8 | −684.917980 | 34.873566 | | | 136.6 |
| 9 | 241.422752 | 35.713905 | SIO2 | 1.560482 | 121.0 |
| 10 | −361.299306 | 18.993524 | | | 127.8 |
| 11 | −288.440063 | 14.242352 | SIO2 | 1.560482 | 113.1 |
| 12 | 179.464943 | 37.588950 | | | 113.8 |
| 13 | −105.508464 | 7.389366 | SIO2 | 1.560482 | 113.9 |
| 14 | −111.803827 | 12.704220 | | | 111.7 |
| 15 | −196.390717 | 63.788275 | SIO2 | 1.560482 | 113.1 |
| 16 | −120.783079 | 87.743334 | | | 113.1 |
| 17 | −679.540594 | 41.970510 | SIO2 | 1.560482 | 138.0 |
| 18 | −241.624790 | 1.000044 | | | 141.0 |
| 19 | 699.438799 | 56.855696 | SIO2 | 1.560482 | 145.0 |
| 20 | −369.028847 | 81.055211 | | | 144.7 |
| 21 | 0.000000 | −151.491439 | REFL | | 113.9 |
| 22 | −157.883241 | −54.800425 | SIO2 | 1.560482 | 121.4 |
| 23 | −1311.973283 | −145.368315 | | | 119.3 |
| 24 | 244.803241 | −12.500000 | SIO2 | 1.560482 | 113.1 |
| 25 | −283.214281 | −68.638235 | | | 113.8 |
| 26 | 95.740517 | −12.500000 | SIO2 | 1.560482 | 113.9 |
| 27 | 388.051305 | −31.771956 | | | 128.8 |
| 28 | 150.732461 | 31.771956 | REFL | | 125.6 |
| 29 | 388.051305 | 12.500000 | SIO2 | 1.560482 | 130.2 |
| 30 | 95.740517 | 68.638235 | | | 113.9 |
| 31 | −283.214281 | 12.500000 | SIO2 | 1.560482 | 111.7 |
| 32 | 244.803241 | 145.368315 | | | 113.1 |
| 33 | −1311.973283 | 54.800425 | SIO2 | 1.560482 | 113.9 |
| 34 | −157.883241 | 151.491439 | | | 116.9 |
| 35 | 0.000000 | −90.878883 | REFL | | 113.9 |
| 36 | −475.489077 | −46.349472 | SIO2 | 1.560482 | 154.8 |
| 37 | 581.864274 | −0.999648 | | | 155.5 |
| 38 | −779.312951 | −41.136118 | SIO2 | 1.560482 | 157.4 |
| 39 | 565.485540 | −0.999682 | | | 157.3 |
| 40 | −152.494534 | −69.349336 | SIO2 | 1.560482 | 132.8 |
| 41 | −113.950140 | −51.617204 | | | 113.1 |
| 42 | −6302.557436 | −9.999362 | SIO2 | 1.560482 | 113.8 |
| 43 | −129.990794 | −66.551327 | | | 113.9 |
| 44 | 166.074440 | −9.999724 | SIO2 | 1.560482 | 111.7 |
| 45 | −2857.127171 | −3.328254 | | | 117.3 |
| 46 | −322.990059 | −63.928807 | SIO2 | 1.560482 | 125.1 |
| 47 | 302.111598 | −0.999937 | | | 132.8 |
| 48 | 4416.308416 | −87.994464 | SIO2 | 1.560482 | 142.2 |
| 49 | 200.058742 | −40.421548 | | | 153.2 |
| 50 | −408.663252 | −48.464928 | SIO2 | 1.560482 | 157.3 |
| 51 | 1474.069027 | −1.000120 | | | 155.9 |
| 52 | −275.438531 | −52.315577 | SIO2 | 1.560482 | 149.8 |
| 53 | 29205.559455 | −22.559682 | | | 145.3 |
| 54 | 0.000000 | 21.559927 | | | 136.4 |
| 55 | −219.268849 | −60.026204 | SIO2 | 1.560482 | 130.6 |
| 56 | 972.382073 | −0.999646 | | | 125.4 |
| 57 | −139.244313 | −27.026503 | SIO2 | 1.560482 | 113.8 |
| 58 | −202.749159 | −1.231444 | | | 113.9 |
| 59 | −73.072318 | −60.000998 | SPINELL | 1.910000 | 111.7 |
| 60 | 0.000000 | −3.000000 | HIFLUID | 1.650000 | 113.1 |
| 61 | 0.000000 | 0.000000 | | | 113.1 |

TABLE 2A
Aspheric Constants

| | SRF | | | | |
|---|---|---|---|---|---|
| | 1 | 8 | 12 | 14 | 15 |
| K | 0 | 0 | 0 | 0 | 0 |
| C1 | −6.536549E−08 | −1.467643E−08 | −1.359998E−07 | 1.809509E−07 | −2.537735E−08 |
| C2 | −3.888666E−13 | 4.576040E−12 | −1.112796E−11 | 1.836921E−11 | 3.610369E−12 |
| C3 | −1.105947E−16 | −3.216684E−16 | 5.310252E−15 | 3.661047E−15 | 1.068077E−15 |
| C4 | 8.182589E−21 | 1.561884E−20 | 2.585157E−19 | −7.575863E−20 | −1.201959E−19 |
| C5 | −6.236454E−25 | −3.979318E−25 | −2.349056E−22 | 4.507019E−23 | 1.715469E−23 |
| C6 | 3.701803E−30 | 3.562262E−30 | 3.588815E−26 | −1.277359E−26 | −1.487356E−27 |
| | SRF | | | | |
| | 19 | 23 | 27 | 29 | 33 |
| K | 0 | 0 | 0 | 0 | 0 |
| C1 | −1.977865E−09 | −2.372623E−08 | 3.819797E−08 | 3.819797E−08 | −2.372623E−08 |
| C2 | 6.551868E−14 | −1.335832E−13 | −1.065266E−12 | −1.065266E−12 | −1.335832E−13 |
| C3 | −4.904217E−18 | 1.408397E−17 | 8.177053E−17 | 8.177053E−17 | 1.408397E−17 |
| C4 | 1.755414E−22 | −6.595543E−22 | −2.782496E−21 | −2.782496E−21 | −6.595543E−22 |
| C5 | −4.173941E−27 | 3.076806E−26 | 4.377973E−26 | 4.377973E−26 | 3.076806E−26 |
| C6 | 4.767499E−32 | −5.043637E−31 | 3.648112E−30 | 3.648112E−30 | −5.043637E−31 |
| | SRF | | | | |
| | 36 | 42 | 45 | 46 | 48 |
| K | 0 | 0 | 0 | 0 | 0 |
| C1 | 1.336935E−08 | −2.693453E−08 | −6.545390E−08 | 3.691973E−08 | 3.008028E−08 |
| C2 | −1.812750E−13 | 3.430424E−12 | 1.037597E−12 | −5.750694E−13 | 6.874843E−14 |
| C3 | 1.984189E−18 | −1.229467E−16 | 3.382097E−17 | 3.773141E−17 | −2.594066E−17 |
| C4 | 3.803529E−23 | 4.662629E−21 | 1.854332E−21 | −1.765808E−21 | 2.261587E−22 |
| C5 | −2.625621E−27 | 1.131221E−25 | −7.654063E−26 | 5.120141E−26 | 5.830083E−27 |
| C6 | 4.438084E−32 | −1.200288E−29 | 1.665876E−30 | −7.024381E−31 | −4.224477E−32 |

SRF

| | 51 | 52 | 56 | 58 |
|---|---|---|---|---|
| K | 0 | 0 | 0 | 0 |
| C1 | 1.171269E−08 | 3.766471E−08 | −1.523426E−08 | 2.011507E−07 |
| C2 | −1.181950E−12 | −2.990657E−13 | −1.638177E−14 | −2.669106E−11 |
| C3 | 3.212949E−17 | −4.877301E−17 | −3.439965E−18 | 2.426304E−15 |
| C4 | −9.178102E−22 | 1.637837E−21 | 9.603087E−22 | −2.001511E−19 |
| C5 | 1.800946E−26 | −1.176557E−26 | −1.367726E−26 | 1.057365E−23 |
| C6 | −9.492922E−32 | 5.584241E−32 | −4.529519E−31 | −3.254444E−28 |

TABLE 3

| NA | 1.55 | | | | |
|---|---|---|---|---|---|
| OBH | 61 | THICK- | MA- | | SEMI- |
| SURF | RADIUS | NESS | TERIAL | INDEX | DIAM. |
| 0 | 0.000000 | 49.355983 | | | 61.0 |
| 1 | −723.766986 | 30.000034 | SIO2 | 1.560482 | 78.6 |
| 2 | −199.676472 | 38.800086 | | | 85.5 |
| 3 | −380.594439 | 30.936722 | SIO2 | 1.560482 | 99.8 |
| 4 | −179.699963 | 0.999947 | | | 103.3 |
| 5 | 171.819801 | 55.081848 | SIO2 | 1.560482 | 109.8 |
| 6 | −448.137809 | 34.801025 | | | 108.7 |
| 7 | 206.084116 | 37.633728 | SIO2 | 1.560482 | 88.0 |
| 8 | −454.008719 | 0.999943 | | | 84.4 |
| 9 | 133.195206 | 26.575040 | SIO2 | 1.560482 | 62.4 |
| 10 | 168.298498 | 12.285479 | | | 48.7 |
| 11 | −764.325449 | 9.999825 | SIO2 | 1.560482 | 45.1 |
| 12 | 120.805196 | 23.007021 | | | 49.1 |
| 13 | −234.310612 | 19.200393 | SIO2 | 1.560482 | 54.0 |
| 14 | −149.897439 | 28.779408 | | | 62.6 |
| 15 | −161.981594 | 48.086184 | SIO2 | 1.560482 | 78.5 |
| 16 | −128.374025 | 17.393057 | | | 95.4 |
| 17 | −355.679688 | 38.906402 | SIO2 | 1.560482 | 115.6 |
| 18 | −169.159335 | 0.999789 | | | 119.5 |
| 19 | −1191.175805 | 58.347320 | SIO2 | 1.560482 | 126.0 |
| 20 | −171.433209 | 70.999874 | | | 129.7 |
| 21 | 0.000000 | −137.474252 | REFL | | 106.7 |
| 22 | −186.602836 | −64.159059 | SIO2 | 1.560482 | 118.2 |
| 23 | 692.923157 | −138.649572 | | | 115.9 |
| 24 | 232.747514 | −12.500000 | SIO2 | 1.560482 | 77.6 |
| 25 | −199.780983 | −79.874429 | | | 75.8 |
| 26 | 91.058999 | −12.500000 | SIO2 | 1.560482 | 79.1 |
| 27 | 409.281837 | −33.592852 | | | 103.3 |
| 28 | 147.214411 | 33.592852 | REFL | | 106.9 |
| 29 | 409.281837 | 12.500000 | SIO2 | 1.560482 | 102.7 |
| 30 | 91.058999 | 79.874429 | | | 79.0 |
| 31 | −199.780983 | 12.500000 | SIO2 | 1.560482 | 76.1 |
| 32 | 232.747514 | 138.649572 | | | 78.2 |
| 33 | 692.923157 | 64.159059 | SIO2 | 1.560482 | 119.6 |
| 34 | −186.602836 | 137.474252 | | | 121.7 |
| 35 | 0.000000 | −84.501235 | REFL | | 104.3 |
| 36 | −255.500582 | −49.435323 | SIO2 | 1.560482 | 122.5 |
| 37 | 1081.583033 | −0.999825 | | | 122.0 |
| 38 | −298.820679 | −23.369387 | SIO2 | 1.560482 | 118.0 |
| 39 | −570.258552 | −44.153806 | | | 115.5 |
| 40 | −150.345298 | −36.623169 | SIO2 | 1.560482 | 98.4 |
| 41 | −148.120258 | −53.052235 | | | 86.2 |
| 42 | 158.567521 | −9.999789 | SIO2 | 1.560482 | 84.9 |
| 43 | −142.084341 | −49.846575 | | | 84.5 |
| 44 | 336.256090 | −9.999758 | SIO2 | 1.560482 | 90.1 |
| 45 | 818.623608 | −0.999771 | | | 100.9 |
| 46 | −339.118853 | −43.183751 | SIO2 | 1.560482 | 120.3 |
| 47 | 512.944504 | −24.624628 | | | 126.4 |
| 48 | 437.567291 | −49.492450 | SIO2 | 1.560482 | 134.2 |
| 49 | 179.719260 | −0.999702 | | | 140.0 |
| 50 | −815.150520 | −61.947283 | SIO2 | 1.560482 | 157.9 |
| 51 | 339.222792 | −3.874475 | | | 158.5 |
| 52 | −356.555507 | −52.459178 | SIO2 | 1.560482 | 152.6 |
| 53 | 4578.243931 | −33.811909 | | | 148.6 |
| 54 | 0.000000 | 32.014412 | | | 136.6 |
| 55 | −195.205923 | −64.989914 | SIO2 | 1.560482 | 132.6 |
| 56 | −3690.100501 | −0.999804 | | | 127.1 |
| 57 | −123.197054 | −35.570380 | SIO2 | 1.560482 | 93.3 |
| 58 | −285.996033 | −0.999285 | | | 87.1 |
| 59 | −73.479428 | −60.000245 | SPINELL | 1.910000 | 61.3 |
| 60 | 0.000000 | −3.000000 | HIFLUID | 1.650000 | 23.6 |
| 61 | 0.000000 | 0.000000 | | | 15.3 |

TABLE 3A
Aspheric Constants

| | SRF | | | | |
|---|---|---|---|---|---|
| | 1 | 5 | 11 | 14 | 15 |
| K | 0 | 0 | 0 | 0 | 0 |
| C1 | −6.549724E−08 | −5.513256E−08 | 1.080868E−07 | 2.369229E−07 | 4.276137E−08 |
| C2 | −2.749307E−12 | −1.068091E−12 | −1.205323E−11 | 2.802548E−12 | −3.827038E−12 |
| C3 | 3.933366E−17 | 1.875023E−18 | −3.229580E−15 | 4.349180E−16 | 1.973909E−16 |
| C4 | −9.189294E−21 | 1.412614E−21 | −4.687926E−18 | 9.956308E−20 | 2.573937E−20 |
| C5 | 4.140477E−25 | −1.499428E−25 | 1.981242E−21 | −1.161409E−23 | −5.978864E−25 |
| C6 | −7.486754E−29 | 2.905617E−30 | −2.194406E−25 | −2.337364E−27 | 6.620476E−29 |
| | SRF | | | | |
| | 19 | 23 | 27 | 29 | 33 |
| K | 0 | 0 | 0 | 0 | 0 |
| C1 | −4.068526E−08 | −1.658929E−08 | 4.672118E−08 | 4.672118E−08 | −1.658929E−08 |
| C2 | 5.656232E−13 | −1.206728E−13 | −1.741981E−12 | −1.741981E−12 | −1.206728E−13 |
| C3 | −1.474551E−17 | 1.135300E−17 | 1.344080E−16 | 1.344080E−16 | 1.135300E−17 |
| C4 | 2.252138E−22 | −4.568182E−22 | −6.898051E−21 | −6.898051E−21 | −4.568182E−22 |
| C5 | −7.535189E−27 | 1.333202E−26 | 2.389434E−25 | 2.389434E−25 | 1.333202E−26 |
| C6 | 6.276995E−32 | −2.001139E−31 | −1.119842E−30 | −1.119842E−30 | −2.001139E−31 |
| | SRF | | | | |
| | 37 | 42 | 45 | 46 | 48 |
| K | 0 | 0 | 0 | 0 | 0 |
| C1 | −6.620832E−09 | −6.511554E−08 | −5.161835E−08 | 3.974253E−08 | 6.241486E−08 |
| C2 | 2.388181E−13 | 3.576429E−12 | −2.479199E−12 | −1.955536E−12 | −1.560322E−12 |
| C3 | −3.950354E−18 | −8.352094E−16 | −6.626105E−18 | 1.760281E−16 | −8.467421E−18 |
| C4 | −1.365496E−23 | 8.279947E−20 | 8.307772E−21 | −7.250135E−21 | −1.970202E−21 |
| C5 | 1.531780E−27 | −5.087429E−24 | −6.947990E−25 | 1.743498E−25 | −1.110449E−26 |
| C6 | −1.454170E−32 | 1.477483E−28 | 5.351044E−29 | −9.775462E−31 | 2.312911E−30 |

SRF

| | 51 | 53 | 56 | 58 |
|---|---|---|---|---|
| K | 0 | 0 | 0 | 0 |
| C1 | 1.187086E−08 | −1.229426E−08 | 3.696597E−08 | 1.003280E−07 |
| C2 | −7.588167E−13 | 9.109437E−14 | −5.085047E−12 | −2.426592E−11 |
| C3 | −3.424242E−18 | 5.193722E−17 | 4.783184E−16 | 2.198450E−15 |
| C4 | 4.959605E−22 | −4.184405E−21 | −2.695158E−20 | −1.750181E−19 |
| C5 | −1.042133E−26 | 1.375598E−25 | 7.944554E−25 | 8.549697E−24 |
| C6 | 9.747738E−33 | −1.562147E−30 | −1.008961E−29 | −2.196873E−28 |

TABLE 4

| NA | 1.55 | | | | |
|---|---|---|---|---|---|
| OBH | 61 | THICK- | MA- | | SEMI- |
| SURF | RADIUS | NESS | TERIAL | INDEX | DIAM. |
| 0 | 0.000000 | 35.802907 | | | 61.0 |
| 1 | 940.206900 | 16.882524 | SIO2 | 1.560482 | 75.9 |
| 2 | −300.754255 | 22.030582 | | | 78.1 |
| 3 | −4521.006251 | 34.877318 | SIO2 | 1.560482 | 88.4 |
| 4 | −182.958204 | 40.832698 | | | 90.8 |
| 5 | 1451.943817 | 36.375775 | SIO2 | 1.560482 | 92.1 |
| 6 | −158.031432 | 0.999050 | | | 93.5 |
| 7 | 164.309687 | 33.773170 | SIO2 | 1.560482 | 80.1 |
| 8 | −998.756952 | 0.999782 | | | 76.5 |
| 9 | 111.524017 | 21.160815 | SIO2 | 1.560482 | 60.9 |
| 10 | 302.493679 | 10.350259 | | | 55.3 |
| 11 | −563.880791 | 12.610445 | SIO2 | 1.560482 | 50.6 |
| 12 | 101.957385 | 23.148388 | | | 41.2 |
| 13 | −203.808315 | 44.402657 | SIO2 | 1.560482 | 46.9 |
| 14 | −150.967082 | 44.069348 | | | 65.3 |
| 15 | −190.776189 | 34.229471 | SIO2 | 1.560482 | 87.9 |
| 16 | −155.974610 | 8.538552 | | | 99.1 |
| 17 | −464.194468 | 45.914592 | SIO2 | 1.560482 | 114.5 |
| 18 | −161.444023 | 0.999684 | | | 118.3 |
| 19 | −971.979534 | 50.720079 | SIO2 | 1.560482 | 123.5 |
| 20 | −176.354614 | 70.999764 | | | 127.1 |
| 21 | 0.000000 | −135.683099 | REFL | | 112.1 |
| 22 | −171.645098 | −62.110718 | SIO2 | 1.560482 | 106.8 |
| 23 | 743.347974 | −129.839769 | | | 103.7 |
| 24 | 239.435437 | −12.500000 | SIO2 | 1.560482 | 70.3 |
| 25 | −191.284689 | −61.464735 | | | 68.6 |
| 26 | 83.612903 | −12.500000 | SIO2 | 1.560482 | 70.1 |
| 27 | 426.726176 | −30.308356 | | | 90.0 |
| 28 | 132.247839 | 30.308356 | REFL | | 93.4 |
| 29 | 426.726176 | 12.500000 | SIO2 | 1.560482 | 89.6 |
| 30 | 83.612903 | 61.464735 | | | 70.3 |
| 31 | −191.284689 | 12.500000 | SIO2 | 1.560482 | 69.3 |
| 32 | 239.435437 | 129.839769 | | | 72.2 |
| 33 | 743.347974 | 62.110718 | SIO2 | 1.560482 | 113.3 |
| 34 | −171.645098 | 135.683099 | | | 115.7 |
| 35 | 0.000000 | −72.999883 | REFL | | 110.4 |
| 36 | −219.632010 | −55.565664 | SIO2 | 1.560482 | 119.3 |
| 37 | 720.919039 | −0.999342 | | | 117.5 |
| 38 | −181.965205 | −29.556438 | SIO2 | 1.560482 | 104.7 |
| 39 | −379.465211 | −93.027468 | | | 100.6 |
| 40 | 120.056526 | −9.999656 | SIO2 | 1.560482 | 77.4 |
| 41 | −125.965179 | −45.411068 | | | 76.0 |
| 42 | 331.427684 | −9.999910 | SIO2 | 1.560482 | 81.4 |
| 43 | 720.985333 | −8.980505 | | | 91.0 |
| 44 | −390.301439 | −42.434532 | SIO2 | 1.560482 | 116.1 |
| 45 | 444.904964 | −20.424539 | | | 122.2 |
| 46 | 325.846357 | −39.849502 | SIO2 | 1.560482 | 127.8 |
| 47 | 183.749611 | −0.999936 | | | 133.4 |
| 48 | −780.939705 | −62.916449 | SIO2 | 1.560482 | 152.5 |
| 49 | 303.973062 | −0.999855 | | | 153.5 |
| 50 | −334.700219 | −53.392539 | SIO2 | 1.560482 | 148.7 |
| 51 | 1998.113076 | −34.933494 | | | 144.8 |
| 52 | 0.000000 | 33.933754 | | | 132.5 |
| 53 | −184.712410 | −67.738306 | SIO2 | 1.560482 | 128.8 |
| 54 | 1610.185436 | −0.999289 | | | 123.2 |
| 55 | −129.619368 | −31.727084 | SIO2 | 1.560482 | 90.6 |
| 56 | −356.717172 | −0.998396 | | | 84.6 |
| 57 | −68.614826 | −57.454090 | SPINELL | 1.910000 | 58.4 |
| 58 | 0.000000 | −3.000000 | HIFLUID | 1.650000 | 23.6 |
| 59 | 0.000000 | 0.000000 | | | 15.3 |

TABLE 4A
Aspheric Constants

| | SRF | | | | |
|---|---|---|---|---|---|
| | 1 | 5 | 11 | 14 | 15 |
| K | 0 | 0 | 0 | 0 | 0 |
| C1 | −9.225838E−08 | −1.469807E−07 | 2.211290E−07 | 1.528316E−07 | 3.349640E−08 |
| C2 | −1.459175E−12 | −4.568933E−13 | 1.102299E−11 | 6.053471E−12 | −3.367836E−12 |
| C3 | −7.916279E−17 | 7.533070E−16 | −3.467528E−14 | 9.564181E−16 | 1.281548E−16 |
| C4 | −9.653126E−21 | −7.106054E−20 | 1.389327E−17 | 5.906687E−20 | 4.777574E−21 |
| C5 | 8.463381E−25 | 3.258164E−24 | −2.938087E−21 | 9.432485E−24 | −4.371191E−26 |
| C6 | −1.535437E−28 | −6.276460E−29 | 2.577463E−25 | −2.805747E−27 | 2.907048E−30 |

SRF

| | 19 | 23 | 27 | 29 | 33 |
|---|---|---|---|---|---|
| K | 0 | 0 | 0 | 0 | 0 |
| C1 | −4.758398E−08 | −2.119720E−08 | 6.888627E−08 | 6.888627E−08 | −2.119720E−08 |
| C2 | 5.818536E−13 | −1.084084E−13 | −3.501062E−12 | −3.501062E−12 | −1.084084E−13 |
| C3 | −1.584474E−17 | 1.395882E−17 | 3.474873E−16 | 3.474873E−16 | 1.395882E−17 |
| C4 | 2.434120E−22 | −6.642363E−22 | −2.257579E−20 | −2.257579E−20 | −6.642363E−22 |
| C5 | −1.136746E−26 | 2.604971E−26 | 8.150345E−25 | 8.150345E−25 | 2.604971E−26 |
| C6 | 1.220666E−31 | −5.397892E−31 | 4.932581E−30 | 4.932581E−30 | −5.397892E−31 |

SRF

| | 37 | 40 | 43 | 44 | 46 |
|---|---|---|---|---|---|
| K | 0 | 0 | 0 | 0 | 0 |
| C1 | −1.071710E−08 | −1.843565E−07 | −1.092627E−07 | 2.378695E−08 | 4.173450E−08 |
| C2 | 3.669845E−13 | 6.417509E−12 | −1.525367E−12 | −1.037171E−12 | −8.295657E−13 |
| C3 | −1.076692E−17 | −1.686251E−15 | 8.167736E−18 | 1.587246E−16 | −5.814254E−17 |
| C4 | 1.635646E−22 | 1.762412E−19 | 8.358699E−21 | −8.216916E−21 | −1.330332E−21 |
| C5 | −2.517191E−27 | −1.296238E−23 | −1.552132E−24 | 2.497261E−25 | −1.468622E−26 |
| C6 | 5.097149E−32 | 4.168619E−28 | 2.030612E−28 | −2.671708E−30 | 3.141695E−30 |

SRF

| | 49 | 51 | 54 | 56 |
|---|---|---|---|---|
| K | 0 | 0 | 0 | 0 |
| C1 | 1.095197E−08 | −2.722268E−08 | 8.349698E−09 | 6.502707E−08 |
| C2 | −9.790721E−13 | 9.741806E−13 | −4.888479E−12 | −2.158126E−11 |
| C3 | −1.248179E−18 | 3.316554E−17 | 6.252413E−16 | 1.585331E−15 |
| C4 | 8.959034E−22 | −5.205767E−21 | −4.102356E−20 | −1.043915E−19 |
| C5 | −2.643074E−26 | 2.039774E−25 | 1.354144E−24 | 2.386478E−24 |
| C6 | 1.781380E−31 | −2.566330E−30 | −1.905910E−29 | 1.049137E−29 |

TABLE 5

| NAH | 1.55 | | | | |
|---|---|---|---|---|---|
| OBH | 62 | THICK- | MA- | | SEMI- |
| SURF | RADIUS | NESS | TERIAL | INDEX | DIAM. |
| 0 | 0.000000 | 80.607229 | | | 62.0 |
| 1 | 356.675713 | 27.695243 | SIO2 | 1.560482 | 98.6 |
| 2 | −356.825598 | 17.398241 | | | 100.5 |
| 3 | −891.919783 | 28.072024 | SIO2 | 1.560482 | 107.3 |
| 4 | −274.109552 | 15.035703 | | | 109.8 |
| 5 | −1039.977866 | 36.049090 | SIO2 | 1.560482 | 112.6 |
| 6 | −215.506994 | 42.554377 | | | 114.2 |
| 7 | 361.056197 | 42.822067 | SIO2 | 1.560482 | 101.1 |
| 8 | −276.449559 | 5.894365 | | | 99.1 |
| 9 | 102.507103 | 30.000060 | SIO2 | 1.560482 | 65.4 |
| 10 | 140.795963 | 21.847448 | | | 52.9 |
| 11 | −150.283391 | 9.999624 | SIO2 | 1.560482 | 52.0 |
| 12 | 157.111098 | 43.025315 | | | 56.9 |
| 13 | 3328.273097 | 17.488820 | SIO2 | 1.560482 | 78.0 |
| 14 | −318.593868 | 117.813554 | | | 80.5 |
| 15 | −571.094591 | 44.595967 | SIO2 | 1.560482 | 128.0 |
| 16 | −197.779171 | 0.999193 | | | 132.5 |
| 17 | 1308.612489 | 39.937863 | SIO2 | 1.560482 | 146.6 |
| 18 | −482.032778 | 0.999350 | | | 147.5 |
| 19 | 377.738297 | 67.633510 | SIO2 | 1.560482 | 147.6 |
| 20 | −371.415713 | 71.000331 | | | 146.4 |
| 21 | 0.000000 | −260.964853 | REFL | | 99.9 |
| 22 | 200.921768 | −12.500000 | SIO2 | 1.560482 | 82.2 |
| 23 | −1139.761165 | −57.307111 | | | 88.6 |
| 24 | 112.156614 | −12.500000 | SIO2 | 1.560482 | 91.1 |
| 25 | 377.062433 | −35.301689 | | | 115.3 |
| 26 | 162.131839 | 35.301689 | REFL | | 119.2 |
| 27 | 377.062433 | 12.500000 | SIO2 | 1.560482 | 115.4 |
| 28 | 112.156614 | 57.307111 | | | 91.4 |
| 29 | −1139.761165 | 12.500000 | SIO2 | 1.560482 | 89.2 |
| 30 | 200.921768 | 260.964853 | | | 83.3 |
| 31 | 0.000000 | −72.999701 | REFL | | 98.6 |
| 32 | −352.648714 | −65.598017 | SIO2 | 1.560482 | 140.1 |
| 33 | 332.063873 | −19.996053 | | | 140.8 |
| 34 | −314.476235 | −51.528818 | SIO2 | 1.560482 | 137.1 |
| 35 | 986.324798 | −1.015823 | | | 135.0 |
| 36 | −161.817194 | −85.933651 | SIO2 | 1.560482 | 113.4 |
| 37 | −228.351108 | −28.201202 | | | 85.7 |
| 38 | 379.721491 | −9.999755 | SIO2 | 1.560482 | 83.5 |
| 39 | −95.214267 | −75.278575 | | | 71.3 |
| 40 | 114.006943 | −11.541059 | SIO2 | 1.560482 | 75.1 |
| 41 | 1340.482327 | −1.508671 | | | 95.6 |
| 42 | −322.664244 | −31.480627 | SIO2 | 1.560482 | 110.1 |
| 43 | 1199.277144 | −19.797025 | | | 116.4 |
| 44 | 363.752343 | −62.987672 | SIO2 | 1.560482 | 120.6 |
| 45 | 167.637307 | −0.999920 | | | 131.9 |
| 46 | −519.759430 | −61.232652 | SIO2 | 1.560482 | 159.3 |
| 47 | 412.037642 | −0.999665 | | | 160.0 |
| 48 | −291.651506 | −70.834009 | SIO2 | 1.560482 | 158.8 |
| 49 | 719.492434 | −33.188792 | | | 154.5 |
| 50 | 0.000000 | 32.189282 | | | 139.8 |
| 51 | −209.859470 | −61.704597 | SIO2 | 1.560482 | 135.7 |
| 52 | 66941.324242 | −0.999094 | | | 130.2 |
| 53 | −141.019553 | −39.101171 | SIO2 | 1.560482 | 99.6 |
| 54 | −975.842995 | −0.998366 | | | 93.9 |
| 55 | −73.741371 | −60.000769 | SPINELL | 1.910000 | 61.5 |
| 56 | 0.000000 | −3.000000 | HIFLUID | 1.650000 | 23.8 |
| 57 | 0.000000 | 0.000000 | | | 15.5 |

TABLE 5A
Aspheric Constants

| | SRF | | | | |
|---|---|---|---|---|---|
| | 1 | 5 | 11 | 14 | 15 |
| K | 0 | 0 | 0 | 0 | 0 |
| C1 | −6.838135E−08 | −1.157796E−08 | 2.904638E−07 | 4.437453E−08 | −1.593913E−09 |
| C2 | −1.315129E−12 | −1.760370E−12 | −1.286001E−11 | −2.992583E−12 | −7.268976E−13 |
| C3 | 1.283321E−17 | 2.737858E−16 | −1.617971E−15 | −9.416759E−17 | 3.602954E−17 |
| C4 | −6.981679E−22 | −1.959580E−20 | −1.350164E−18 | −1.167044E−20 | −1.710001E−21 |
| C5 | −4.011863E−26 | 7.275961E−25 | 7.602713E−22 | 4.076006E−25 | 4.885536E−26 |
| C6 | −3.998012E−31 | −1.316476E−29 | −1.462219E−25 | −2.863497E−29 | −8.130615E−31 |
| | SRF | | | | |
| | 19 | 25 | 27 | 33 | 38 |
| K | 0 | 0 | 0 | 0 | 0 |
| C1 | −1.603391E−08 | 2.526092E−08 | 2.526092E−08 | −1.650496E−08 | −6.108035E−08 |
| C2 | 1.417478E−13 | −6.252816E−13 | −6.252816E−13 | −7.530125E−15 | 5.649992E−12 |
| C3 | −6.467047E−18 | 3.870974E−17 | 3.870974E−17 | −3.965762E−19 | −5.624342E−16 |
| C4 | 1.918547E−22 | −1.177840E−21 | −1.177840E−21 | −2.881942E−25 | 6.282329E−20 |
| C5 | −3.306289E−27 | 2.052337E−26 | 2.052337E−26 | −1.667300E−28 | −5.071169E−24 |
| C6 | 2.846562E−32 | 5.683644E−31 | 5.683644E−31 | 5.288070E−33 | 2.166411E−28 |
| | SRF | | | | |
| | 41 | 42 | 44 | 47 | 49 |
| K | 0 | 0 | 0 | 0 | 0 |
| C1 | −1.119744E−07 | 4.435132E−08 | 3.403774E−08 | −6.241191E−09 | −3.024573E−08 |
| C2 | −3.787325E−12 | −2.266569E−12 | −2.080418E−12 | −5.043390E−14 | 5.830227E−13 |
| C3 | 3.763145E−16 | 3.691891E−16 | 9.975799E−18 | −3.331191E−18 | −1.807522E−17 |
| C4 | 3.391903E−20 | −3.078978E−20 | −2.024081E−21 | −1.066723E−22 | 1.018072E−21 |
| C5 | −2.944835E−24 | 1.499267E−24 | −1.463440E−25 | 3.390644E−28 | −2.710620E−26 |
| C6 | 6.542491E−29 | −3.365962E−29 | 1.111226E−29 | 8.580908E−32 | 2.573638E−31 |

SRF

| | 52 | 54 |
|---|---|---|
| K | 0 | 0 |
| C1 | −4.919717E−09 | −2.696517E−08 |
| C2 | −4.497958E−13 | −5.620744E−12 |
| C3 | 1.200576E−16 | 4.358404E−16 |
| C4 | −9.337732E−21 | −3.360028E−20 |
| C5 | 3.160659E−25 | 1.501910E−24 |
| C6 | −4.369394E−30 | −4.861113E−29 |

TABLE 6

| NA | 1.55 | | | | |
|---|---|---|---|---|---|
| OBH | 62 | THICK- | MA- | | SEMI- |
| SURF | RADIUS | NESS | TERIAL | INDEX | DIAM. |
| 0 | 0.000000 | 36.400451 | | | 62.0 |
| 1 | 3396.166719 | 23.099260 | SIO2 | 1.560482 | 76.3 |
| 2 | 542.887576 | 6.055812 | | | 86.8 |
| 3 | 819.212024 | 39.973413 | SIO2 | 1.560482 | 89.7 |
| 4 | −199.469740 | 67.803169 | | | 93.8 |
| 5 | −1481.119597 | 51.534590 | SIO2 | 1.560482 | 114.4 |
| 6 | −161.469313 | 14.798333 | | | 117.7 |
| 7 | 303.120450 | 78.244658 | SIO2 | 1.560482 | 107.2 |
| 8 | −393.962886 | 11.729998 | | | 97.3 |
| 9 | 168.526111 | 29.998748 | SIO2 | 1.560482 | 74.2 |
| 10 | 181.152503 | 20.758626 | | | 61.5 |
| 11 | 0.000000 | 0.000000 | SIO2 | 1.560482 | 55.0 |
| 12 | 0.000000 | 16.728790 | | | 55.0 |
| 13 | −190.863846 | 9.999447 | SIO2 | 1.560482 | 57.7 |
| 14 | 212.076186 | 24.902376 | | | 63.9 |
| 15 | 854.727317 | 17.894899 | SIO2 | 1.560482 | 77.1 |
| 16 | −306.544119 | 126.349499 | | | 79.6 |
| 17 | −2365.390399 | 58.421996 | SIO2 | 1.560482 | 137.9 |
| 18 | −197.860673 | 0.998981 | | | 142.2 |
| 19 | −1610.428207 | 34.307915 | SIO2 | 1.560482 | 149.0 |
| 20 | −362.239224 | 8.329442 | | | 150.0 |
| 21 | 395.015553 | 67.109812 | SIO2 | 1.560482 | 145.2 |
| 22 | −365.045971 | 85.892562 | | | 143.0 |
| 23 | 0.000000 | −218.784912 | REFL | | 82.9 |
| 24 | 151.808529 | −12.500000 | SIO2 | 1.560482 | 78.9 |
| 25 | 26253.733524 | −46.054548 | | | 87.8 |
| 26 | 123.277302 | −12.500000 | SIO2 | 1.560482 | 90.5 |
| 27 | 425.825445 | −36.270368 | | | 110.9 |
| 28 | 155.283325 | 36.270368 | REFL | | 115.5 |
| 29 | 425.825445 | 12.500000 | SIO2 | 1.560482 | 111.0 |
| 30 | 123.277302 | 46.054548 | | | 90.4 |
| 31 | 26253.733524 | 12.500000 | SIO2 | 1.560482 | 87.6 |
| 32 | 151.808529 | 218.784912 | | | 78.7 |
| 33 | 0.000000 | −82.999452 | REFL | | 83.2 |
| 34 | −410.340183 | −62.212863 | SIO2 | 1.560482 | 139.0 |
| 35 | 285.960725 | −0.969660 | | | 141.2 |
| 36 | −249.799323 | −62.997443 | SIO2 | 1.560482 | 146.1 |
| 37 | 2097.368122 | −4.988393 | | | 143.8 |
| 38 | −189.432086 | −65.355937 | SIO2 | 1.560482 | 122.5 |
| 39 | −396.571805 | −40.411084 | | | 104.1 |
| 40 | 275.602802 | −9.998696 | SIO2 | 1.560482 | 96.4 |
| 41 | −105.992957 | −70.750607 | | | 80.9 |
| 42 | 136.454155 | −14.326773 | SIO2 | 1.560482 | 82.5 |
| 43 | −2052.288508 | −1.548825 | | | 104.8 |
| 44 | −305.707643 | −53.571922 | SIO2 | 1.560482 | 130.7 |
| 45 | 322.071334 | −3.706809 | | | 131.9 |
| 46 | 603.013476 | −84.680711 | SIO2 | 1.560482 | 134.0 |
| 47 | 176.397367 | −3.391498 | | | 143.9 |
| 48 | −583.542704 | −74.606564 | SIO2 | 1.560482 | 159.5 |
| 49 | 711.692769 | −0.999904 | | | 159.3 |
| 50 | −250.846826 | −70.693388 | SIO2 | 1.560482 | 154.3 |
| 51 | 1117.164251 | −1.000453 | | | 148.3 |
| 52 | −318.325216 | −48.533000 | SIO2 | 1.560482 | 135.6 |
| 53 | 2225.604560 | −0.999814 | | | 130.6 |
| 54 | −144.031390 | −40.152477 | SIO2 | 1.560482 | 100.7 |
| 55 | −652.518507 | −0.999696 | | | 95.4 |
| 56 | −74.385216 | −60.000913 | SPINELL | 1.910000 | 65.4 |
| 57 | 0.000000 | −3.000000 | HIFLUID | 1.650000 | 65.5 |
| 58 | 0.000000 | 0.000000 | | | 70.7 |

TABLE 6A
Aspheric Constants

| | SRF | | | | |
|---|---|---|---|---|---|
| | 1 | 5 | 13 | 16 | 17 |
| K | 0 | 0 | 0 | 0 | 0 |
| C1 | −8.343754E−08 | −3.085443E−08 | 2.805898E−07 | 1.046732E−07 | −2.433233E−08 |
| C2 | −1.590126E−12 | −1.978972E−12 | −1.755344E−11 | −2.491273E−12 | −8.757202E−14 |
| C3 | 5.570853E−18 | 1.868697E−16 | 5.244385E−16 | −1.471927E−16 | 2.106500E−17 |
| C4 | −2.624326E−20 | −1.136067E−20 | −7.498660E−19 | −2.672986E−20 | −1.029686E−21 |
| C5 | 2.814274E−24 | 4.476908E−25 | 1.610507E−22 | 5.983236E−25 | 2.478731E−26 |
| C6 | −2.573077E−28 | −8.143956E−30 | −2.121554E−26 | 2.640302E−29 | −3.200906E−31 |
| | SRF | | | | |
| | 21 | 27 | 29 | 35 | 40 |
| K | 0 | 0 | 0 | 0 | 0 |
| C1 | −1.028431E−08 | 3.874212E−08 | 3.874212E−08 | −1.204962E−08 | −2.034864E−08 |
| C2 | 9.402581E−14 | −1.281564E−12 | −1.281564E−12 | −4.967105E−14 | 1.092837E−12 |
| C3 | −2.470018E−18 | 8.433411E−17 | 8.433411E−17 | −1.838647E−18 | −2.162139E−16 |
| C4 | −7.225077E−23 | −3.515044E−21 | −3.515044E−21 | 1.453723E−23 | 1.936512E−20 |
| C5 | 4.030893E−27 | 1.057245E−25 | 1.057245E−25 | −1.445034E−28 | −1.132296E−24 |
| C6 | −4.878299E−32 | −9.423188E−32 | −9.423188E−32 | 5.374403E−33 | 4.145359E−29 |
| | SRF | | | | |
| | 43 | 44 | 46 | 49 | 51 |
| K | 0 | 0 | 0 | 0 | 0 |
| C1 | −4.834269E−08 | 5.109852E−08 | 5.749588E−08 | −7.820945E−09 | −3.340604E−08 |
| C2 | 6.870856E−13 | −8.190374E−13 | −3.243876E−13 | 3.500105E−13 | −2.945123E−13 |
| C3 | −4.943606E−17 | −4.953878E−18 | −1.238762E−17 | 3.080490E−20 | 3.746920E−17 |
| C4 | 2.386408E−21 | 3.651896E−21 | 4.531511E−23 | −1.275245E−21 | 2.684242E−22 |
| C5 | −1.121214E−25 | −2.061048E−25 | −1.310762E−25 | 4.480586E−26 | −3.254037E−26 |
| C6 | 1.663273E−29 | 4.552186E−30 | 2.907282E−30 | −4.445199E−31 | 3.389595E−31 |

SRF

| | 53 | 55 |
|---|---|---|
| K | 0 | 0 |
| C1 | 2.866699E−08 | 8.046757E−09 |
| C2 | −1.789691E−12 | −4.681190E−12 |
| C3 | 3.726386E−17 | 5.918235E−16 |
| C4 | −8.728147E−22 | −5.786636E−20 |
| C5 | 8.013906E−27 | 3.458104E−24 |
| C6 | 3.542933E−32 | −1.008558E−28 |

TABLE 7

| NA | 1.55 | | | | |
|---|---|---|---|---|---|
| OBH | 63 | THICK- | MA- | | SEMI- |
| SURF | RADIUS | NESS | TERIAL | INDEX | DIAM. |
| 0 | 0.000000 | 57.725440 | | | 63.0 |
| 1 | −329.273633 | 42.367161 | SIO2 | 1.560482 | 109.0 |
| 2 | −171.131491 | 0.999821 | | | 128.9 |
| 3 | 201.759437 | 52.295472 | SIO2 | 1.560482 | 169.1 |
| 4 | −1003.459343 | 0.999385 | | | 187.0 |
| 5 | 254.013014 | 42.229737 | SIO2 | 1.560482 | 141.4 |
| 6 | −735.772043 | 44.816379 | | | 147.0 |
| 7 | 129.601486 | 58.028654 | SIO2 | 1.560482 | 113.3 |
| 8 | 167.031713 | 25.605525 | | | 113.9 |
| 9 | −92.070585 | 22.727297 | SIO2 | 1.560482 | 113.7 |
| 10 | −95.701228 | 64.278609 | | | 112.0 |
| 11 | −171.888858 | 41.499658 | SIO2 | 1.560482 | 113.3 |
| 12 | −135.767199 | 0.999364 | | | 113.3 |
| 13 | −1974.855000 | 47.930814 | SIO2 | 1.560482 | 153.8 |
| 14 | −242.611028 | 0.999072 | | | 153.4 |
| 15 | 666.276503 | 52.395037 | SIO2 | 1.560482 | 180.3 |
| 16 | −305.357895 | 80.998432 | | | 178.9 |
| 17 | 0.000000 | −129.638243 | REFL | | 167.0 |
| 18 | −149.043939 | −57.287643 | SIO2 | 1.560482 | 144.4 |
| 19 | −1612.739455 | −145.138900 | | | 161.8 |
| 20 | 172.200512 | −12.500000 | SIO2 | 1.560482 | 113.3 |
| 21 | −358.196319 | −59.248972 | | | 117.9 |
| 22 | 92.719808 | −12.500000 | SIO2 | 1.560482 | 113.7 |
| 23 | 548.062167 | −37.865545 | | | 140.1 |
| 24 | 142.114792 | 37.865545 | REFL | | 130.4 |
| 25 | 548.062167 | 12.500000 | SIO2 | 1.560482 | 140.6 |
| 26 | 92.719808 | 59.248972 | | | 113.7 |
| 27 | −358.196319 | 12.500000 | SIO2 | 1.560482 | 132.3 |
| 28 | 172.200512 | 145.138900 | | | 113.3 |
| 29 | −1612.739455 | 57.287643 | SIO2 | 1.560482 | 113.3 |
| 30 | −149.043939 | 129.638243 | | | 115.1 |
| 31 | 0.000000 | −87.031330 | REFL | | 121.1 |
| 32 | −397.651290 | −60.623722 | SIO2 | 1.560482 | 164.8 |
| 33 | 358.949532 | −0.998831 | | | 164.0 |
| 34 | −405.603074 | −35.401307 | SIO2 | 1.560482 | 159.7 |
| 35 | 3960.541698 | −0.999299 | | | 159.8 |
| 36 | −226.643165 | −43.263019 | SIO2 | 1.560482 | 141.9 |
| 37 | −779.674013 | −35.957890 | | | 132.2 |
| 38 | 209.583631 | −9.998508 | SIO2 | 1.560482 | 150.8 |
| 39 | −108.253955 | −88.640969 | | | 113.7 |
| 40 | 269.881184 | −9.999542 | SIO2 | 1.560482 | 112.0 |
| 41 | −1694.688408 | −1.245320 | | | 138.9 |
| 42 | −245.547377 | −101.720444 | SIO2 | 1.560482 | 116.7 |
| 43 | 204.970018 | −0.999353 | | | 127.8 |
| 44 | −3890.558318 | −9.999176 | SIO2 | 1.560482 | 131.4 |
| 45 | −1912.860213 | −19.657520 | | | 131.9 |
| 46 | −264.378715 | −88.310518 | SIO2 | 1.560482 | 143.4 |
| 47 | 306.318218 | −33.772128 | | | 144.3 |
| 48 | 0.000000 | 32.772956 | | | 125.5 |
| 49 | −186.051665 | −61.903928 | SIO2 | 1.560482 | 123.2 |
| 50 | 1286.615086 | −4.139964 | | | 118.6 |
| 51 | −109.439383 | −38.473267 | SIO2 | 1.560482 | 113.3 |
| 52 | −315.125131 | −0.995369 | | | 113.3 |
| 53 | −92.125651 | −60.003281 | LUAG | 2.143828 | 113.9 |
| 54 | 0.000000 | −3.000000 | HIIL | 1.640000 | 113.7 |
| 55 | 0.000000 | 0.000000 | | | 114.8 |

TABLE 7A
Aspheric Constants

| | SRF | | | | |
|---|---|---|---|---|---|
| | 1 | 6 | 8 | 10 | 11 |
| K | 0 | 0 | 0 | 0 | 0 |
| C1 | −1.018803E−07 | −9.467159E−08 | −2.101814E−07 | 2.532056E−07 | 4.273546E−08 |
| C2 | 8.270425E−13 | 1.672989E−11 | 1.200627E−12 | 2.848870E−11 | 1.052470E−12 |
| C3 | −2.605660E−16 | −1.286887E−15 | 2.180864E−14 | 2.806950E−15 | −1.651610E−17 |
| C4 | 3.359294E−20 | 6.455853E−20 | −8.780082E−18 | 5.539199E−19 | 3.894068E−21 |
| C5 | −9.426146E−25 | −1.750770E−24 | 2.708295E−21 | −8.846623E−23 | −2.338009E−25 |
| C6 | 1.693593E−30 | 1.712643E−29 | −3.043315E−25 | −3.114917E−27 | 4.524877E−30 |
| | SRF | | | | |
| | 16 | 19 | 23 | 25 | 29 |
| K | 0 | 0 | 0 | 0 | 0 |
| C1 | 1.977557E−08 | −3.422905E−08 | 6.854464E−08 | 6.854464E−08 | −3.422905E−08 |
| C2 | −3.077967E−13 | −2.794255E−13 | −4.139035E−12 | −4.139035E−12 | −2.794255E−13 |
| C3 | 9.261222E−18 | 2.194448E−17 | 3.739244E−16 | 3.739244E−16 | 2.194448E−17 |
| C4 | −2.850746E−22 | −1.633577E−21 | −2.354271E−20 | −2.354271E−20 | −1.633577E−21 |
| C5 | 7.663222E−27 | 1.252895E−25 | 8.722392E−25 | 8.722392E−25 | 1.252895E−25 |
| C6 | −1.019844E−31 | −3.197759E−30 | −6.310527E−30 | −6.310527E−30 | −3.197759E−30 |
| | SRF | | | | |
| | 32 | 37 | 38 | 41 | 42 |
| K | 0 | 0 | 0 | 0 | 0 |
| C1 | 1.276530E−08 | 2.653830E−08 | −9.946027E−08 | −1.003485E−07 | 5.343895E−08 |
| C2 | −8.791851E−14 | 6.387084E−13 | 8.075459E−12 | 1.096554E−12 | −1.005211E−12 |
| C3 | 7.219197E−19 | 1.481473E−17 | −6.550055E−16 | 1.992551E−16 | 5.036636E−17 |
| C4 | 3.823539E−22 | 2.610006E−21 | 3.946957E−20 | 5.096751E−21 | −6.462953E−21 |
| C5 | −2.193399E−26 | −4.303260E−25 | −1.879413E−24 | −1.368136E−24 | 3.299899E−25 |
| C6 | 4.345565E−31 | 1.352468E−29 | 4.863518E−29 | 4.814814E−29 | −5.380672E−30 |

SRF

| | 45 | 46 | 50 | 52 |
|---|---|---|---|---|
| K | 0 | 0 | 0 | 0 |
| C1 | 3.323395E−08 | 5.452848E−08 | −7.964424E−09 | 5.159778E−08 |
| C2 | −1.949621E−12 | −5.313721E−13 | −5.385781E−13 | −3.406025E−11 |
| C3 | 1.124867E−17 | −4.749996E−17 | 1.241292E−16 | 5.816506E−15 |
| C4 | 6.743303E−22 | 1.644425E−21 | −1.290692E−20 | −8.231241E−19 |
| C5 | −1.042044E−25 | −2.053988E−26 | 5.936747E−25 | 7.122729E−23 |
| C6 | 2.905558E−30 | 2.416120E−31 | −1.142857E−29 | −3.236613E−27 |

TABLE 8

| NA | 1.55 | | | | |
|---|---|---|---|---|---|
| Y′ | 15.75 | THICK- | MA- | | SEMI- |
| SURF | RADIUS | NESS | TERIAL | INDEX | DIAM. |
| 0 | 0.000000 | 65.242546 | | | 63.0 |
| 1 | −5309.741190 | 18.651044 | SIO2 | 1.560482 | 88.2 |
| 2 | −301.527120 | 1.808599 | | | 91.7 |
| 3 | 267.132813 | 39.054975 | SIO2 | 1.560482 | 105.9 |
| 4 | 220.215008 | 13.262398 | | | 108.3 |
| 5 | 319.173721 | 76.519148 | SIO2 | 1.560482 | 110.7 |
| 6 | −239.956740 | 1.270638 | | | 114.6 |
| 7 | 300.780469 | 51.208529 | SIO2 | 1.560482 | 110.5 |
| 8 | −651.099295 | 30.388885 | | | 106.1 |
| 9 | 217.434507 | 36.026525 | SIO2 | 1.560482 | 86.3 |
| 10 | −378.758618 | 20.837739 | | | 82.8 |
| 11 | −302.959857 | 9.999753 | SIO2 | 1.560482 | 56.2 |
| 12 | 198.363436 | 38.651899 | | | 56.7 |
| 13 | −105.258949 | 10.972476 | SIO2 | 1.560482 | 62.1 |
| 14 | −105.860971 | 11.925857 | | | 69.9 |
| 15 | −166.500347 | 61.376429 | SIO2 | 1.560482 | 79.1 |
| 16 | −117.940450 | 94.908480 | | | 97.0 |
| 17 | −861.366382 | 41.214928 | SIO2 | 1.560482 | 139.0 |
| 18 | −261.171446 | 0.999862 | | | 141.7 |
| 19 | 725.581222 | 55.091755 | SIO2 | 1.560482 | 145.0 |
| 20 | −389.134375 | 82.715338 | | | 144.6 |
| 21 | 0.000000 | −150.214298 | REFL | | 106.7 |
| 22 | −158.966592 | −54.346173 | SIO2 | 1.560482 | 114.6 |
| 23 | −1290.844054 | −152.577240 | | | 111.4 |
| 24 | 201.580648 | −12.500000 | SIO2 | 1.560482 | 80.5 |
| 25 | −307.005783 | −70.600235 | | | 81.0 |
| 26 | 97.594197 | −12.500000 | SIO2 | 1.560482 | 83.4 |
| 27 | 381.116104 | −33.288884 | | | 106.5 |
| 28 | 153.008223 | 33.288884 | REFL | | 110.6 |
| 29 | 381.116104 | 12.500000 | SIO2 | 1.560482 | 106.8 |
| 30 | 97.594197 | 70.600235 | | | 83.6 |
| 31 | −307.005783 | 12.500000 | SIO2 | 1.560482 | 81.5 |
| 32 | 201.580648 | 152.577240 | | | 81.3 |
| 33 | −1290.844054 | 54.346173 | SIO2 | 1.560482 | 114.0 |
| 34 | −158.966592 | 150.214298 | | | 117.0 |
| 35 | 0.000000 | −85.309519 | REFL | | 105.4 |
| 36 | −385.689862 | −53.340995 | SIO2 | 1.560482 | 140.5 |
| 37 | 552.228914 | −0.999739 | | | 141.4 |
| 38 | −854.569904 | −32.934510 | SIO2 | 1.560482 | 140.3 |
| 39 | 863.614881 | −0.999831 | | | 139.5 |
| 40 | −166.584877 | −77.403935 | SIO2 | 1.560482 | 124.0 |
| 41 | −116.326219 | −47.040713 | | | 91.2 |
| 42 | −1334.351619 | −9.999598 | SIO2 | 1.560482 | 90.5 |
| 43 | −137.609554 | −62.005113 | | | 86.8 |
| 44 | 187.461531 | −9.999929 | SIO2 | 1.560482 | 89.9 |
| 45 | −1036.589719 | −7.632456 | | | 109.6 |
| 46 | −1533.936308 | −62.965677 | SIO2 | 1.560482 | 130.3 |
| 47 | 303.374893 | −7.368860 | | | 136.6 |
| 48 | 1818.949681 | −82.327503 | SIO2 | 1.560482 | 148.3 |
| 49 | 197.094732 | −41.418942 | | | 156.8 |
| 50 | −421.373961 | −46.626497 | SIO2 | 1.560482 | 160.0 |
| 51 | 2397.496923 | −1.239786 | | | 158.5 |
| 52 | −293.741441 | −47.838895 | SIO2 | 1.560482 | 152.7 |
| 53 | 52946.994785 | −27.887455 | | | 148.4 |
| 54 | 0.000000 | 26.887782 | | | 137.7 |
| 55 | −209.424136 | −65.534531 | SIO2 | 1.560482 | 133.1 |
| 56 | 1094.929195 | −0.999404 | | | 128.1 |
| 57 | −128.018105 | −29.089489 | SIO2 | 1.560482 | 91.2 |
| 58 | −197.880255 | −0.998677 | | | 85.0 |
| 59 | −73.943965 | −59.957823 | SPINELL | 1.910000 | 61.6 |
| 60 | 0.000000 | −3.000000 | HIFLUID | 1.650000 | 24.1 |
| 61 | 0.000000 | 0.000000 | | | 15.8 |

TABLE 8A
Aspheric Constants

| | SRF | | | | |
|---|---|---|---|---|---|
| | 1 | 8 | 12 | 14 | 15 |
| K | 0 | 0 | 0 | 0 | 0 |
| C1 | −6.642419E−08 | −2.034460E−08 | −1.144404E−07 | 2.214309E−07 | 1.654242E−08 |
| C2 | −3.908334E−13 | 5.320327E−12 | −8.332561E−12 | 1.066901E−11 | −3.711036E−12 |
| C3 | −1.078107E−16 | −3.783119E−16 | 4.775289E−15 | 4.221224E−15 | 2.319386E−15 |
| C4 | 7.294908E−21 | 1.791302E−20 | 8.530504E−19 | −1.668334E−19 | −2.633506E−19 |
| C5 | −6.102594E−25 | −4.205724E−25 | −3.481330E−22 | 5.509010E−23 | 3.455536E−23 |
| C6 | −1.342592E−30 | 2.556085E−30 | 3.889506E−26 | −1.067606E−26 | −2.471798E−27 |
| | SRF | | | | |
| | 19 | 23 | 27 | 29 | 33 |
| K | 0 | 0 | 0 | 0 | 0 |
| C1 | −7.493832E−10 | −2.302094E−08 | 3.660068E−08 | 3.660068E−08 | −2.302094E−08 |
| C2 | 5.987060E−14 | −1.268255E−13 | −9.916535E−13 | −9.916535E−13 | −1.268255E−13 |
| C3 | −5.180535E−18 | 1.386216E−17 | 7.113987E−17 | 7.113987E−17 | 1.386216E−17 |
| C4 | 1.950953E−22 | −7.108440E−22 | −1.767454E−21 | −1.767454E−21 | −7.108440E−22 |
| C5 | −4.786229E−27 | 3.418859E−26 | −1.272034E−26 | −1.272034E−26 | 3.418859E−26 |
| C6 | 5.594154E−32 | −6.116210E−31 | 4.102760E−30 | 4.102760E−30 | −6.116210E−31 |
| | SRF | | | | |
| | 36 | 42 | 45 | 46 | 48 |
| K | 0 | 0 | 0 | 0 | 0 |
| C1 | 1.210023E−08 | −9.125837E−09 | −6.835233E−08 | 3.343583E−08 | 2.358941E−08 |
| C2 | −1.929604E−13 | 4.099416E−12 | 1.299449E−12 | −8.063567E−13 | 9.021678E−14 |
| C3 | 3.415646E−18 | −6.477670E−17 | 9.593298E−17 | 5.247517E−17 | −1.306461E−17 |
| C4 | −1.335855E−23 | 1.133341E−21 | −2.818214E−23 | −2.454825E−21 | −3.771661E−22 |
| C5 | −1.352158E−27 | 1.551508E−25 | −1.865773E−25 | 5.947986E−26 | 2.809843E−26 |
| C6 | 3.001208E−32 | −1.800660E−29 | 4.899602E−30 | −5.887864E−31 | −3.748019E−31 |

SRF

| | 51 | 52 | 56 | 58 |
|---|---|---|---|---|
| K | 0 | 0 | 0 | 0 |
| C1 | 1.832778E−08 | 4.096083E−08 | −4.413655E−09 | 1.785774E−07 |
| C2 | −1.176932E−12 | −2.506855E−13 | −4.997212E−13 | −2.671815E−11 |
| C3 | 2.008097E−17 | −5.227259E−17 | 3.170468E−17 | 2.575279E−15 |
| C4 | −2.775114E−22 | 1.799408E−21 | −9.161344E−22 | −2.353813E−19 |
| C5 | −9.608112E−28 | −1.944039E−26 | 1.982871E−26 | 1.372483E−23 |
| C6 | 1.327528E−31 | 1.199264E−31 | −4.112412E−31 | −4.721783E−28 |

TABLE 9

| NA | 1.55 | | | | |
|---|---|---|---|---|---|
| Y′ | 15.75 | THICK- | MA- | | SEMI- |
| SURF | RADIUS | NESS | TERIAL | INDEX | DIAM. |
| 0 | 0.000000 | 65.443946 | | | 63.0 |
| 1 | −1382.073817 | 20.238033 | SIO2 | 1.560482 | 87.5 |
| 2 | −269.384488 | 1.027532 | | | 91.7 |
| 3 | 265.682279 | 35.407116 | SIO2 | 1.560482 | 106.6 |
| 4 | 213.210939 | 13.577802 | | | 108.8 |
| 5 | 295.969233 | 88.340556 | SIO2 | 1.560482 | 111.9 |
| 6 | −233.723151 | 0.999656 | | | 116.7 |
| 7 | 320.139451 | 39.381563 | SIO2 | 1.560482 | 111.1 |
| 8 | −619.518749 | 36.675335 | | | 108.7 |
| 9 | 226.551026 | 42.062236 | SIO2 | 1.560482 | 86.5 |
| 10 | −336.117190 | 15.955094 | | | 80.7 |
| 11 | −291.714706 | 10.000114 | SIO2 | 1.560482 | 57.9 |
| 12 | 184.083058 | 41.589331 | | | 56.6 |
| 13 | −115.687640 | 9.277327 | SIO2 | 1.560482 | 63.7 |
| 14 | −111.726918 | 11.998544 | | | 70.2 |
| 15 | −176.207118 | 68.947648 | SIO2 | 1.560482 | 79.2 |
| 16 | −124.728193 | 90.653107 | | | 100.3 |
| 17 | −999.372983 | 40.486697 | SIO2 | 1.560482 | 139.6 |
| 18 | −275.219730 | 0.999971 | | | 142.2 |
| 19 | 842.220168 | 54.537290 | SIO2 | 1.560482 | 145.0 |
| 20 | −368.364558 | 81.004663 | | | 144.7 |
| 21 | 0.000000 | −149.384523 | REFL | | 106.7 |
| 22 | −160.703918 | −53.672279 | SIO2 | 1.560482 | 115.0 |
| 23 | −1311.163431 | −154.815354 | | | 111.9 |
| 24 | 207.558675 | −12.500000 | SIO2 | 1.560482 | 80.9 |
| 25 | −303.058567 | −70.081390 | | | 81.4 |
| 26 | 97.237647 | −12.500000 | SIO2 | 1.560482 | 83.5 |
| 27 | 387.439008 | −33.806413 | | | 107.1 |
| 28 | 152.880457 | 33.806413 | REFL | | 111.0 |
| 29 | 387.439008 | 12.500000 | SIO2 | 1.560482 | 107.4 |
| 30 | 97.237647 | 70.081390 | | | 83.7 |
| 31 | −303.058567 | 12.500000 | SIO2 | 1.560482 | 81.8 |
| 32 | 207.558675 | 154.815354 | | | 81.5 |
| 33 | −1311.163431 | 53.672279 | SIO2 | 1.560482 | 114.0 |
| 34 | −160.703918 | 149.384523 | | | 116.8 |
| 35 | 0.000000 | −86.277663 | REFL | | 105.5 |
| 36 | −396.200443 | −48.972371 | SIO2 | 1.560482 | 141.4 |
| 37 | 698.285219 | −7.207504 | | | 142.4 |
| 38 | −859.007634 | −38.566245 | SIO2 | 1.560482 | 142.6 |
| 39 | 614.939401 | −1.073343 | | | 142.1 |
| 40 | −158.630188 | −74.693675 | SIO2 | 1.560482 | 124.2 |
| 41 | −110.582269 | −50.753904 | | | 91.0 |
| 42 | −1274.969827 | −9.999365 | SIO2 | 1.560482 | 90.3 |
| 43 | −135.957723 | −62.101721 | | | 86.7 |
| 44 | 202.535171 | −10.000560 | SIO2 | 1.560482 | 90.6 |
| 45 | −1615.141595 | −3.851653 | | | 109.0 |
| 46 | −1222.369845 | −68.483942 | SIO2 | 1.560482 | 128.4 |
| 47 | 294.837638 | −11.880662 | | | 135.8 |
| 48 | 1242.156502 | −91.689975 | SIO2 | 1.560482 | 147.4 |
| 49 | 201.732015 | −12.870689 | | | 160.0 |
| 50 | −422.359992 | −43.166755 | SIO2 | 1.560482 | 160.0 |
| 51 | 3778.874067 | −0.999698 | | | 158.4 |
| 52 | −280.982341 | −52.651815 | SIO2 | 1.560482 | 152.9 |
| 53 | 12943.894420 | −33.562707 | | | 148.2 |
| 54 | 0.000000 | 32.563207 | | | 133.7 |
| 55 | −204.205773 | −61.999974 | SIO2 | 1.560482 | 130.1 |
| 56 | 1369.000420 | −0.999019 | | | 124.7 |
| 57 | −152.328499 | −26.215621 | SIO2 | 1.560482 | 94.5 |
| 58 | −227.802167 | −0.998268 | | | 88.9 |
| 59 | −80.017163 | −9.999498 | SIO2 | 1.560482 | 64.3 |
| 60 | −57.067575 | −51.998425 | SPINELL | 1.910000 | 51.4 |
| 61 | 0.000000 | −3.000000 | HIFLUID | 1.650000 | 24.1 |
| 62 | 0.000000 | 0.000000 | | | 15.8 |

TABLE 9A
Aspheric Constants

| | SRF | | | | |
|---|---|---|---|---|---|
| | 1 | 8 | 12 | 14 | 15 |
| K | 0 | 0 | 0 | 0 | 0 |
| C1 | −6.737019E−08 | −1.477939E−08 | −1.425035E−07 | 2.172013E−07 | 1.631771E−08 |
| C2 | −3.973238E−13 | 4.527407E−12 | −8.328016E−12 | 1.133758E−11 | −2.146629E−12 |
| C3 | −9.874758E−17 | −2.954276E−16 | 5.097520E−15 | 3.689411E−15 | 1.997266E−15 |
| C4 | 4.674927E−21 | 1.355460E−20 | 7.775449E−19 | −1.371922E−19 | −2.240389E−19 |
| C5 | −3.887977E−25 | −3.088318E−25 | −3.523120E−22 | 3.415628E−23 | 2.869770E−23 |
| C6 | −9.157373E−30 | 2.931646E−30 | 4.404411E−26 | −8.365217E−27 | −2.107692E−27 |
| | SRF | | | | |
| | 19 | 23 | 27 | 29 | 33 |
| K | 0 | 0 | 0 | 0 | 0 |
| C1 | −1.501509E−09 | −2.176993E−08 | 3.760081E−08 | 3.760081E−08 | −2.176993E−08 |
| C2 | 7.091916E−14 | −1.286901E−13 | −1.052921E−12 | −1.052921E−12 | −1.286901E−13 |
| C3 | −5.347754E−18 | 1.363293E−17 | 7.605175E−17 | 7.605175E−17 | 1.363293E−17 |
| C4 | 1.992419E−22 | −7.028001E−22 | −2.132801E−21 | −2.132801E−21 | −7.028001E−22 |
| C5 | −4.926111E−27 | 3.375604E−26 | 3.322568E−27 | 3.322568E−27 | 3.375604E−26 |
| C6 | 5.812675E−32 | −6.066583E−31 | 3.895195E−30 | 3.895195E−30 | −6.066583E−31 |
| | SRF | | | | |
| | 36 | 42 | 45 | 46 | 48 |
| K | 0 | 0 | 0 | 0 | 0 |
| C1 | 1.212657E−08 | −3.080262E−09 | −6.867903E−08 | 3.589074E−08 | 2.404973E−08 |
| C2 | −1.728660E−13 | 3.825403E−12 | 1.053207E−12 | −6.461860E−13 | 2.044550E−13 |
| C3 | 3.441782E−18 | −7.959445E−17 | 6.604586E−17 | 3.274895E−17 | −1.965263E−17 |
| C4 | −4.176328E−23 | 1.135563E−21 | 4.755161E−22 | −1.397203E−21 | −3.372134E−22 |
| C5 | −1.328972E−28 | 1.435956E−25 | −1.557236E−26 | 3.504476E−26 | 3.199061E−26 |
| C6 | 1.050360E−32 | −9.147314E−30 | −3.743949E−31 | −3.868982E−31 | −4.524166E−31 |

SRF

| | 51 | 52 | 56 | 58 |
|---|---|---|---|---|
| K | 0 | 0 | 0 | 0 |
| C1 | 1.623140E−08 | 3.819213E−08 | −8.892560E−09 | 1.925227E−07 |
| C2 | −1.175769E−12 | −2.298310E−13 | −4.744729E−13 | −2.654576E−11 |
| C3 | 1.948750E−17 | −5.465438E−17 | 2.384439E−17 | 2.559570E−15 |
| C4 | −3.172537E−22 | 1.662817E−21 | −2.280459E−22 | −2.186727E−19 |
| C5 | 3.040805E−28 | −1.194998E−26 | 1.880757E−26 | 1.192084E−23 |
| C6 | 1.556828E−31 | 9.178701E−32 | −9.130595E−31 | −3.532718E−28 |

TABLE 10

| NA | 1.55 | | | | |
|---|---|---|---|---|---|
| Y′ | 15.75 | THICK- | MA- | | SEMI- |
| SURF | RADIUS | NESS | TERIAL | INDEX | DIAM. |
| 0 | 0.000000 | 62.981669 | | | 63.0 |
| 1 | −2754.999212 | 18.171999 | SIO2 | 1.560482 | 87.1 |
| 2 | −264.042772 | 3.556370 | | | 90.0 |
| 3 | 275.831562 | 39.873058 | SIO2 | 1.560482 | 104.2 |
| 4 | 213.762883 | 13.972347 | | | 106.8 |
| 5 | 308.079117 | 84.341217 | SIO2 | 1.560482 | 109.8 |
| 6 | −230.275967 | 1.523287 | | | 114.6 |
| 7 | 319.689368 | 39.153571 | SIO2 | 1.560482 | 109.8 |
| 8 | −615.549816 | 30.771974 | | | 107.5 |
| 9 | 219.335150 | 40.608246 | SIO2 | 1.560482 | 87.3 |
| 10 | −355.728524 | 17.387632 | | | 82.4 |
| 11 | −312.464038 | 11.487918 | SIO2 | 1.560482 | 58.0 |
| 12 | 182.354749 | 38.593771 | | | 56.4 |
| 13 | −114.954318 | 10.888592 | SIO2 | 1.560482 | 62.4 |
| 14 | −108.613284 | 12.078103 | | | 69.0 |
| 15 | −176.428484 | 68.249779 | SIO2 | 1.560482 | 78.2 |
| 16 | −126.585484 | 92.240623 | | | 99.6 |
| 17 | −780.092848 | 40.315956 | SIO2 | 1.560482 | 138.9 |
| 18 | −259.495393 | 0.999854 | | | 141.7 |
| 19 | 764.249548 | 56.062656 | SIO2 | 1.560482 | 145.0 |
| 20 | −375.485824 | 81.620080 | | | 144.7 |
| 21 | 0.000000 | −145.313680 | REFL | | 107.1 |
| 22 | −160.342627 | −53.969798 | SIO2 | 1.560482 | 115.3 |
| 23 | −1193.557266 | −156.590437 | | | 112.1 |
| 24 | 201.005956 | −12.500000 | SIO2 | 1.560482 | 80.9 |
| 25 | −310.242512 | −70.459301 | | | 81.5 |
| 26 | 96.569001 | −12.500000 | SIO2 | 1.560482 | 83.6 |
| 27 | 383.731506 | −33.993364 | | | 108.0 |
| 28 | 152.638892 | 33.993364 | REFL | | 111.7 |
| 29 | 383.731506 | 12.500000 | SIO2 | 1.560482 | 106.8 |
| 30 | 96.569001 | 70.459301 | | | 83.2 |
| 31 | −310.242512 | 12.500000 | SIO2 | 1.560482 | 81.2 |
| 32 | 201.005956 | 156.590437 | | | 80.9 |
| 33 | −1193.557266 | 53.969798 | SIO2 | 1.560482 | 114.5 |
| 34 | −160.342627 | 145.313680 | | | 117.4 |
| 35 | 0.000000 | −84.794333 | REFL | | 105.9 |
| 36 | −378.434419 | −53.371465 | SIO2 | 1.560482 | 141.1 |
| 37 | 578.593181 | −7.435403 | | | 142.0 |
| 38 | −1018.212102 | −31.938937 | SIO2 | 1.560482 | 140.8 |
| 39 | 813.781787 | −2.607139 | | | 140.1 |
| 40 | −162.155344 | −80.191454 | SIO2 | 1.560482 | 124.3 |
| 41 | −110.646046 | −48.640252 | | | 89.8 |
| 42 | −1153.775588 | −9.999282 | SIO2 | 1.560482 | 89.2 |
| 43 | −136.119753 | −61.300582 | | | 86.2 |
| 44 | 201.636450 | −10.741942 | SIO2 | 1.560482 | 90.3 |
| 45 | −1257.522390 | −2.856342 | | | 110.2 |
| 46 | −1189.819935 | −69.199316 | SIO2 | 1.560482 | 127.4 |
| 47 | 294.511335 | −13.946995 | | | 135.7 |
| 48 | 1696.036484 | −88.289124 | SIO2 | 1.560482 | 149.7 |
| 49 | 200.838647 | −13.183977 | | | 160.1 |
| 50 | −430.324485 | −42.512906 | SIO2 | 1.560482 | 160.2 |
| 51 | 4030.725661 | −0.995538 | | | 158.6 |
| 52 | −276.767875 | −54.610604 | SIO2 | 1.560482 | 153.0 |
| 53 | 12295.251662 | −34.196725 | | | 148.2 |
| 54 | 0.000000 | 33.209588 | | | 132.9 |
| 55 | −210.977905 | −58.297104 | SIO2 | 1.560482 | 129.8 |
| 56 | 1874.273987 | −0.956339 | | | 124.6 |
| 57 | −152.260774 | −28.362272 | SIO2 | 1.560482 | 96.2 |
| 58 | −240.471726 | −0.883258 | | | 90.7 |
| 59 | −81.559634 | −9.963002 | SIO2 | 1.560482 | 65.1 |
| 60 | −58.494116 | −0.933933 | | | 52.4 |
| 61 | −57.174831 | −51.968060 | SPINELL | 1.910000 | 51.5 |
| 62 | 0.000000 | −3.000000 | HIFLUID | 1.650000 | 24.1 |
| 63 | 0.000000 | 0.000000 | | | 15.8 |

TABLE 10A
Aspheric Constants

| | SRF | | | | |
|---|---|---|---|---|---|
| | 1 | 8 | 12 | 14 | 15 |
| K | 0 | 0 | 0 | 0 | 0 |
| C1 | −6.900239E−08 | −1.296907E−08 | −1.130168E−07 | 2.077138E−07 | 8.333608E−09 |
| C2 | −1.886458E−13 | 4.313162E−12 | −1.095079E−11 | 1.174708E−11 | −1.703695E−12 |
| C3 | −9.068587E−17 | −3.003943E−16 | 5.232042E−15 | 3.934168E−15 | 1.983541E−15 |
| C4 | 1.001404E−22 | 1.451732E−20 | 8.037817E−19 | −1.334832E−19 | −2.270202E−19 |
| C5 | −6.764383E−26 | −3.830797E−25 | −3.101799E−22 | 4.960029E−23 | 2.780600E−23 |
| C6 | −1.768090E−29 | 4.308945E−30 | 3.541844E−26 | −1.146728E−26 | −2.089680E−27 |
| | SRF | | | | |
| | 19 | 23 | 27 | 29 | 33 |
| K | 0 | 0 | 0 | 0 | 0 |
| C1 | −1.855299E−09 | −2.080579E−08 | 3.783871E−08 | 3.783871E−08 | −2.080579E−08 |
| C2 | 8.263649E−14 | −1.562181E−13 | −1.073042E−12 | −1.073042E−12 | −1.562181E−13 |
| C3 | −5.494601E−18 | 1.281067E−17 | 7.683400E−17 | 7.683400E−17 | 1.281067E−17 |
| C4 | 1.916548E−22 | −5.364347E−22 | −2.472236E−21 | −2.472236E−21 | −5.364347E−22 |
| C5 | −4.465670E−27 | 2.528179E−26 | 4.574060E−26 | 4.574060E−26 | 2.528179E−26 |
| C6 | 5.138253E−32 | −5.004489E−31 | 2.138824E−30 | 2.138824E−30 | −5.004489E−31 |
| | SRF | | | | |
| | 36 | 42 | 45 | 46 | 48 |
| K | 0 | 0 | 0 | 0 | 0 |
| C1 | 1.180660E−08 | 3.208768E−09 | −6.389266E−08 | 3.647098E−08 | 2.456155E−08 |
| C2 | −1.747156E−13 | 4.063768E−12 | 1.280741E−12 | −5.560134E−13 | 1.743608E−13 |
| C3 | 3.717676E−18 | −6.209793E−17 | 6.619416E−17 | 3.630839E−17 | −2.279144E−17 |
| C4 | −7.924586E−23 | 5.624452E−21 | 9.439195E−22 | −2.009520E−21 | −2.615261E−22 |
| C5 | 1.523803E−27 | −6.707992E−25 | −1.737915E−25 | 4.566295E−26 | 3.174407E−26 |
| C6 | −1.572795E−32 | 2.167583E−29 | 6.289153E−30 | −3.761681E−31 | −3.637661E−31 |

SRF

| | 51 | 52 | 56 | 58 |
|---|---|---|---|---|
| K | 0 | 0 | 0 | 0 |
| C1 | 1.666577E−08 | 3.672661E−08 | −7.974293E−09 | 1.974460E−07 |
| C2 | −1.171620E−12 | −2.685070E−13 | −7.086588E−13 | −2.668922E−11 |
| C3 | 1.867656E−17 | −5.459259E−17 | 3.846149E−17 | 2.613563E−15 |
| C4 | −3.270791E−22 | 1.706344E−21 | −1.100874E−21 | −2.224982E−19 |
| C5 | 1.450499E−27 | −1.390275E−26 | 7.727163E−26 | 1.211234E−23 |
| C6 | 1.453276E−31 | 1.586830E−31 | −2.223260E−30 | −3.531804E−28 |

What is claimed is:

1. A catadioptric projection objective comprising:
a plurality of optical elements arranged along an optical axis to image a pattern from an object field in an object surface of the objective to an image field in an image surface region of the objective at an image-side numerical aperture NA with electromagnetic radiation defining an operating wavelength λ, including:
a first objective part configured to image the pattern from the object surface into a first intermediate image, and having a first pupil surface;
a second objective part configured to image the first intermediate image into a second intermediate image, and having a second pupil surface optically conjugate to the first pupil surface, the second objective part including a concave mirror having a reflective mirror surface positioned at or close to the second pupil surface;
a third objective part configured to image the second intermediate image into the image surface, and having a third pupil surface optically conjugate to the first and second pupil surface;
a first deflecting mirror arranged to deflect radiation from the object surface towards the concave mirror;
a second deflecting mirror arranged to deflect radiation from the concave mirror towards the image surface such that the image surface is parallel to the object surface;
wherein NA≧1.35 and a geometrical distance L between the object surface and the image surface is smaller than or equal to 1950 mm.

2. Projection objective according to claim 1, wherein NA≧1.45 and L≦1700 mm.

3. Projection objective according to claim 1, wherein the projection objective has an image-side numerical aperture NA≧1.50.

4. Projection objective according to claim 1, wherein the projection objective has an image-side numerical aperture NA≧1.55

5. Projection objective according to claim 1, wherein a circular design object field centred around the optical axis has a design object field radius R_{DOF}, where the projection objective is essentially corrected with respect to image aberrations in zones having radial coordinates smaller than R_{DOF} and wherein the projection objective is not fully corrected in zones having radial coordinates larger than R_{DOF}, where β is a magnification ratio of the projection objective, and where the condition 120>B=|L/(R_{DOF}*β)| holds.

6. Projection objective according to claim 5, wherein B<110.

7. Projection objective according to claim 1, further comprising a field lens with positive refractive power arranged geometrically between the first deflecting mirror and the concave mirror.

8. Projection objective according to claim 7, wherein the field lens is arranged geometrically between the concave mirror and the deflecting mirrors in a region through which the beam passes twice in such a manner that a first lens area of the field lens is arranged in the beam path between the object plane and the concave mirror, and a second lens area of the field lens is arranged in the beam path between the concave mirror and the image plane.

9. Projection objective according to claim 7, wherein the field lens is arranged optically close to both the first intermediate image and the second intermediate image in a region in which the chief ray height is larger than the marginal ray height.

10. Projection objective according to claim 7, wherein the field lens is arranged between the first intermediate image and the concave mirror.

11. Projection objective according to claim 7, wherein the field lens is a single lens.

12. Projection objective according to claim 7, wherein the field lens has at least one aspheric lens surface.

13. Projection objective according to claim 1, wherein the projection objective has an immersion lens group having a convex object-side entry surface bounding at a gas or vacuum and an image-side exit surface in contact with an immersion liquid in operation, wherein the immersion lens group is at least partly made of a high-index material with refractive index n≧1.6 at the operating wavelength.

14. Projection objective according to claim 13, wherein the immersion lens group is a monolithic piano-convex lens made of the high-index material.

15. Projection objective according to claim 13, wherein the immersion lens group includes at least two optical elements in optical contact with each other along a splitting interface, where at least one of the optical elements forming the immersion lens group consists of a high-index material with refractive index n≧1.6.

16. Projection objective according to claim 13, wherein the high-index material is chosen from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

17. Projection objective according to claim 1, wherein the high-index material is transparent for ultraviolet radiation having a wavelength λ<260 nm.

18. Projection objective according to claim 13, wherein the immersion lens group includes a piano-convex composite lens having an image-side plano-convex second lens element having a convex entry surface and an essentially planar exit surface, and a meniscus shaped object-side first lens element having a convex entry surface and a concave exit surface in optical contact with the convex entry surface of the second lens element.

19. Projection objective according to claim 18, wherein the first lens element has a first refractive index n1 which is smaller than the second refractive index n2 of the second lens element.

20. Projection objective according to claim 19, wherein the condition Δn≧0.08 holds for a refractive index difference Δn=n2−n1.

21. Projection objective according to claim 18, wherein a gap between the concave exit surface of the object-side first lens element and the convex entry surface of the image-side second lens element is free of gas.

22. Projection objective according to claim 21, wherein the gap is filled with an immersion liquid.

23. Projection objective according to claim 18, wherein the first lens element is made of fused silica (SiO₂).

24. Projection objective according to claim 18, wherein the second lens element is made from a high-index material chosen from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

25. Projection objective according to claim 18, wherein the concave exit surface of the object-side first lens element has a curvature ρ₂ the convex entry surface of the image-side second lens element has a curvature ρ₃ and the condition L*|ρ₂−ρ₃|<5 holds.

26. Projection objective according to claim 18, wherein the convex entry surface of the object-side first lens element has a curvature ρ₁, the concave exit surface of the object-side first lens element has a curvature ρ₂ and the condition L*|ρ₁−ρ₂|<15 holds.

27. Projection objective according to claim 18, wherein the convex entry surface of the object-side first lens element has a curvature pi, the concave exit surface of the object-side first lens element has a curvature ρ₂ and the condition L*|ρ₁+ρ₂|>15 holds.

28. Projection objective according to claim 1, wherein the third objective part has, in this order between the second intermediate image and the image surface, a first lens group with positive refractive power having a maximum diameter D₁, a second lens group with negative refractive power defining a waist region where a beam diameter of a radiation beam passing through the third objective has a local minimum with minimum diameter D₂, and a third lens group with positive refractive power, where the condition A>1.3 holds for the diameter ratio A=D₁/D₂.

29. Projection objective according to claim 1, wherein the first objective part is a refractive objective part.

30. Projection objective according to claim 1, wherein the third objective part is a refractive objective part.

31. Projection objective according to claim 1, wherein a negative group comprising at least one negative lens is arranged in front of the concave mirror on a reflecting side thereof in a double pass region such that radiation passes at least twice in opposite directions through the negative group.

32. Projection objective according to claim 1, further comprising a variable aperture stop having an aperture stop edge that determines the aperture stop diameter, where an axial position of the aperture stop edge with reference to the optical axis of the projection objective varies as a function of the aperture stop diameter.

33. Projection objective according to claim 32, wherein the aperture stop is designed as a spherical aperture stop or as a conical aperture stop.

34. Projection objective according to claim 32, wherein the aperture stop is axially displaceable.

35. Projection objective according to claim 32, wherein the aperture stop is arranged in the third objective part at or close to the third pupil surface.

36. Projection objective according to claim 1, further comprising a variable aperture stop arranged in the first objective part at or close to the first pupil surface.

37. Projection objective according to claim 36, wherein the aperture stop is a planar aperture stop.

38. A projection exposure apparatus comprising:
a light source generating primary radiation;
an illumination system forming the primary radiation to generate illumination radiation incident on a mask bearing a pattern;
a projection objective according to claim 1 projecting an image of the pattern onto a radiation-sensitive substrate.

39. A catadioptric projection objective comprising:
a plurality of optical elements arranged along a folded optical axis to image a pattern from an object field in an object surface of the objective to an image field in an image surface region of the objective at an image-side numerical aperture NA≧1.50 with ultraviolet radiation defining an operating wavelength λ≦260 nm, including:
a first objective part configured to image the pattern from the object surface into a first intermediate image;
a second objective part configured to image the first intermediate image into a second intermediate image, the second objective part including a concave mirror having a reflective mirror surface positioned at or close to a pupil surface of the second objective part;
a third objective part configured to image the second intermediate image into the image surface;
a first deflecting mirror arranged to deflect radiation from the object surface towards the concave mirror; and
a second deflecting mirror arranged to deflect radiation from the concave mirror towards the image surface such that the image surface is parallel to the object surface a geometrical distance L between the object surface and the image surface at a geometrical distance L from the object surface.

40. Projection objective according to claim 39, wherein L≦1700 mm.

41. Projection objective according to claim 39, wherein NA≧1.55

42. Projection objective according to claim 39, wherein a circular design object field centred around the optical axis has a design object field radius R_{DOF}, where the projection objective is essentially corrected with respect to image aberrations in zones having radial coordinates smaller than R_{DOF} and wherein the projection objective is not fully corrected in zones having radial coordinates larger than R_{DOF}, where β is a magnification ratio of the projection objective, and where the condition 120>B=|L/(R_{DOF}*β)| holds.

43. Projection objective according to claim 39, wherein the projection objective has an immersion lens group having a convex object-side entry surface bounding at a gas or vacuum and an image-side exit surface in contact with an immersion liquid in operation, wherein the immersion lens group is at least partly made of a high-index material with refractive index n≧1.6 at the operating wavelength.

44. Projection objective according to claim 43, wherein the high-index material is chosen from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

45. Projection objective according to claim 43, further comprising a field lens with positive refractive power arranged geometrically between the concave mirror and the deflecting mirrors in a region through which the beam passes twice in such a manner that a first lens area of the field lens is arranged in the beam path between the object plane and the concave mirror, and a second lens area of the field lens is arranged in the beam path between the concave mirror and the image plane.

46. Projection objective according to claim 45, wherein the field lens is arranged optically close to both the first intermediate image and the second intermediate image in a region in which a chief ray height is larger than a marginal ray height.
